(19) United States
(12) Patent Application Publication
(10) Pub. No.: US 2024/0056940 A1
(43) Pub. Date: Feb. 15, 2024

(54) MANAGEMENT OF RADIO LINK FAILURE AND DEFICIENCIES IN INTEGRATED ACCESS BACKHAULED NETWORKS

(71) Applicant: CANON KABUSHIKI KAISHA, Tokyo (JP)

(72) Inventors: Pascal LAGRANGE, LA CHAPELLE DES FOUGERETZ (FR); Pierre VISA, RENNES (FR); Philippe LE BARS, THORIGNE-FOUILLARD (FR)

(21) Appl. No.: 18/260,533

(22) PCT Filed: Dec. 31, 2021
(86) PCT No.: PCT/EP2021/087911

§ 371 Date: Jul. 6, 2023

(30) Foreign Application Priority Data
Jan. 6, 2021 (GB) 2100155.7
Jan. 13, 2021 (GB) 2100426.2

(51) Int. Cl. H04W 40/22; H04W 40/12; H04W 40/24

(52) U.S. Cl. CPC H04W 40/22; H04W 40/12; H04W 40/248

(57) ABSTRACT

In an IAB network, an IAB-node detects a deficiency or failure of one BH link. A BH RLF indication message is sent to its child IAB-nodes specifying the BAP paths that are impacted, a quality of those paths and the deficient radio link by indicating the other IAB-node sharing the link. Same message are transmitted to this sharing IAB-node, but also to the IAB-donor in order to adapt the routing configuration of the IAB-nodes to the topology. BAP packets for the impacted BAP paths are rerouted using alternative BAP paths. IAB-nodes receiving the BH RLF indication message also apply routing strategies for the impacted BAP paths, taking into account the indicated quality. A similar message is transmitted when the BH radio link experiences recovery, so that the IAB-nodes stop rerouting the BAP packets and the IAB-donor restore the original routing configuration.

### FIELD OF THE INVENTION

The present invention generally relates to wireless communications, in particular in Integrated Access and Backhaul (IAB) networks.

### BACKGROUND OF THE INVENTION

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems-based IEEE 802.11 standards, such as WiFi.

The demand for network densification increases due to the rising number of users and higher throughput requirement.

Facing the issue of high deployment costs and time of the wired backhauling networks, 3GPP has proposed, in recent release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications (between base stations) may use the same radio resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate.

However, millimeter waves are known to be subject to strong attenuations of signal strength in some weather conditions (rain, fog), and to blockage in case of obstacles located in the path between the emitter and the receiver.

To cope with these potential radio link failures, a topological redundancy can be provided within the IAB framework, where multiple data paths are set up between the IAB base station directly connected to the core network (also referred to as the “IAB-donor”) and the IAB base station serving a UE (also referred to as the “access IAB-node” for the UE). Several intermediate IAB base stations (also referred to as IAB-nodes) may be involved in each of the several paths between the IAB-donor and the access IAB-node, thus forming alternative data paths within a multi-hop IAB network.

A path through a set of IAB-nodes is defined by default along which the data are preferably transmitted. Also, one or more back-up paths along different sets of IAB-nodes are defined that can be used in case a radio link failure (RLF) occurs on any link of the default path. A link is defined between two successive IAB-nodes in the backhaul network.

In the IAB-network topology, the direction from the IAB-donor toward the access IAB-nodes (and thus the UEs) is referred to as downstream, hence defining a parent IAB-node and a child IAB-node for each link. The direction toward the IAB-donor is referred to as upstream. Each IAB-node is made of an IAB-MT (IAB-Mobile Termination) to communicate in the upstream direction and of an IAB-DU (IAB-Distributed Unit) to communicate in the downstream direction.

To prevent, or at least, limit service interruption due to RLF, 3GPP introduced in TS 38.840 v16.1.0, a so-called BH RLF indication message. When a BH RLF recovery failure is detected at the IAB-MT, the collocated IAB-DU (more precisely an internal Backhaul Adaptation Protocol (BAP) entity) sends such BH RLF indication message over all or part of its egress links associated with the IAB-DU. The message is a mere Control Protocol Data Unit, PDU, in which a 4-bit PDU Type is set to “BH RLF indication”.

Upon receiving such BH RLF indication from a parent IAB-DU, any child IAB-node can perform a BH link re-establishment, i.e. it can connect to a different parent IAB-node. This aims at providing alternate BAP paths to transmit BAP packets. The child IAB-node thus no longer has BH connectivity with the detecting IAB-node having detected the RLF.

Some evolutions of this mechanism provide that the child IAB-node may forward the BH RLF indication to its own child IAB-nodes, should the child IAB-node be unable to connect to a different parent IAB-node.

Other evolutions allow the BH RLF indication to be sent by the detecting IAB-node, prior to any RLF recovery attempt, and also to indicate when the failed radio link has been recovered.

This RLF indication mechanism is not fully satisfactory.

In particular, the child IAB-node may try to either reroute packets to a different parent IAB-node or to perform a BH link re-establishment.

However, the choice of the new parent IAB-node is made without knowledge of the IAB-network topology from the IAB-node perspective, hence without knowledge of which paths would be advantageous.

Also, a systematic BH link re-establishment may not be efficient should the failed radio link be recovered in a close future.

Furthermore, the child IAB-node finding an alternate BAP path usually decides to reroute all the received BAP packets (e.g. intended to the IAB-donor) to this alternate BAP path, hence introducing an interruption of service and creating risks of congestion on the egress link. Indeed, some of the received BAP packets may not need to be rerouted, for instance if their BAP paths are not impacted by the RLF.

In addition, no mechanism is provided that could help the IAB-nodes to dynamically or pro-actively adapt their BAP packet routing scheme, should the radio link concerned be not fully failing but only be partly deficient (e.g. with a reduced radio link quality).

More efficient BH radio link management mechanisms are thus required to supplement the existing 3GPP IAB framework.

### SUMMARY OF THE INVENTION

The present invention proposes a method in a wireless communication network comprising an Integrated Access and Backhaul, IAB, network, the method comprising, at a detecting IAB-node having Backhaul, BH, radio links established with other IAB-nodes:
detecting a change in link conditions of one of the BH radio links, and responsive to the detection, sending an indication message to at least one of the other IAB-nodes,
wherein the indication message indicates a detected link condition change in the IAB network and further provides information relating to the BH radio link.

While the 3GPP Re1.16 only provides a BH RLF indication only indicating a detected link condition change in the IAB network, the present invention intends to provide more specific information regarding the BH radio link concerned by the link condition change.

This additional information helps for instance the child IAB-nodes to adapt more finely their strategy for rerouting BAP packets or re-establish a link with another parent IAB-node. In other words, the present invention also proposes a method in a wireless communication network comprising an Integrated Access and Backhaul, IAB, network, the method comprising, at a routing IAB-node:
receiving, from another IAB-node, an indication message, wherein the indication message indicates a detected link condition change in the IAB network and further provides information relating to a BH radio link concerned by the link condition change,
deciding to adapt, based on the received information, a routing of Backhaul Adaptation Protocol, BAP, packets between routing over an impacted BAP path involving the BH radio link and routing over an alternate BAP path. The rerouting may for instance result from re-establishing a link with another parent IAB-node or choosing another BAP path already available.

The above shows that enhanced adaptation of BAP packet routing can be made locally given the information relating to the BH radio link in question. Such adaptation may be temporary until either the deficient BH radio link is recovered ora routing configuration of the IAB-nodes is modified by the IAB-donor given the evolving topology of the IAB network.

In this perspective, the present invention also provides a method in a wireless communication network comprising an Integrated Access and Backhaul, IAB, network, the method comprising, at an IAB-donor of the IAB network:
receiving an indication message issued by a detecting IAB-node, wherein the indication message indicates a detected link condition change in the IAB network and further provides information relating to a BH radio link concerned by the link condition change,
deciding to adapt, based on the received information, a routing configuration of IAB-nodes, i.e. modifying the routing configuration tables, hence the BAP paths within the network given the state of the BH radio link. This is made possible thanks to the additional information that helps the IAB-donor to identify the concerned BH radio link. New resulting BH Routing Configuration tables can be sent to the IAB-nodes.

Correlatively, the invention also provides a wireless communication device comprising at least one microprocessor configured for carrying out the steps of any of the above methods.

Optional features of embodiments of the invention are defined in the appended claims. Some of these features are explained here below with reference to a method, while they can be transposed into device features.

In some embodiments, the information relating to the BH radio links signals the BH radio link experiences a radio link deficiency, for instance RLF, or a radio link recovery. This helps the various IAB-nodes receiving the indication message, for instance the child IAB-nodes, to search either to implement other rerouting of BAP packets or to stop existing rerouting.

In some embodiments, the information relating to the BH radio links signals one or more impacted Backhaul Adaptation Protocol, BAP, paths involving (i.e. that go through or use) the BH radio link. For instance, the information may be a BAP Path ID or may be a BAP Routing ID (which includes a Path ID in addition to a Destination address). Any IAB-node receiving the indication message is thus aware of which BAP paths are impacted by either a deficiency or a recovery of the BH radio link. The IAB-node may thus concentrate its strategy for rerouting or stopping rerouting over these specific BAP paths, hence reducing risks of congestion over alternate BAP paths and processing load.

In specific embodiments, the information relating to the BH radio link further includes link condition information relating to each impacted BAP path. This aims at giving indication to the IAB-nodes on the level of deficiency or recovery of the impacted BAP path. Therefore, the IAB-nodes are able to implement optimized strategy to keep, choose or reuse some impacted BAP paths rather than others. Hence, network efficiency is improved in the IAB network.

More generally, the information relating to the BH radio link may include link condition information relating to the BH radio link.

In specific embodiments, the link condition information includes one or a combination of
a radio link quality level of the BH radio link. This estimates the quality at the radio link level only,
a congestion level of the BH radio link. This estimates the congestion at the link level only, for instance based on a filling level of transmission buffer at the detecting IAB-node,
a path quality level of an impacted Backhaul Adaptation Protocol, BAP, path involving the BH radio link. This gives a quality indication for the entire BAP path and not only for the radio link level concerned. In the simplest manner, this may adjust a predefined or shared path quality level with the radio link quality level of the BH radio link,
a confidence level of recovery from a radio link failure of the BH radio link. Such basic information already helps the IAB-nodes receiving the indication message to decide whether or not to reestablish a link with another parent or child IAB-node or to reroute BAP packets (should the recovery be highly probable in a short time or not).

In some embodiments, the information relating to the BH radio link signals a sharing IAB-node sharing the BH radio link (with the detecting IAB-node). The concerned BH link can then be precisely identified. Also, this information helps intermediate IAB-nodes to forward the indication message to that sharing IAB-node of the BH radio link, for instance for it to take appropriate measures (e.g. rerouting of downstream BAP packets).

In some embodiments, the indication message further includes a field signalling whether the indication message is to be forwarded to an IAB-donor of the IAB network. This field helps intermediate IAB-nodes to forward the indication message to that IAB-donor. As mentioned above, this contributes to obtain at the end an adaptation of the routing configuration at the IAB-nodes by the IAB-donor (given the impacted network topology).

In some embodiments, the indication message includes a BH radio link failure, RLF, indication as defined in 3GPP TS 38.340 V16.1.0. In other words, the fields provided in this standard document are kept and supplemented with one or more additional fields carrying the above information.

In this context, the invention also provides a Control protocol data unit, PDU, for backhaul, BH, radio link failure, RLF, indication including a one-byte header, a field of which taking a value indicating a detected link condition change in an Integrated Access and Backhaul, IAB, network, wherein the Control PDU further includes additional information relating to a BH radio link concerned by the link condition change.

In particular, the additional information may include one or more RLF Indication entries associated with one or more respective BAP paths. Each entry may include all or part of the information mentioned above.

The various types of information that can be provided in the indication message involves various possible operations at the detecting IAB-node. From its perspective, detecting a change may include detecting a deficiency in the BH radio link, i.e. the link conditions of the BH radio link move from an operational state to a deficient state. The deficiency may affect partly the BH radio link (e.g. a degraded quality of the link is observed or sensed) or affect the entire capacity of the BH radio link (in which case a radio link failure is experienced).

In a variant, detecting a change includes detecting a recovery of the BH radio link previously deficient, i.e. the link conditions of the BH radio link move from the deficient state to the operational state.

In some embodiments that can be combined with the above, detecting a change includes detecting a radio link failure or a recovery from a radio link failure, or comparing a radio link quality level of the BH radio link to a quality threshold (i.e. detecting a change in the quality of the radio link), or comparing a congestion level of the BH radio link to a congestion threshold (i.e. detecting a change in the congestion level over the radio link). Different quality thresholds (or congestion thresholds) may be used to distinguish between detecting a deficiency of the BH radio link and a recovery thereof. In that way, one understands that a BH radio link is said to be deficient when its link quality becomes lower than the threshold, and the BH radio link is said to be recovered when its link quality becomes higher than the same or other threshold.

In some embodiments, the other IAB-node or nodes to which the indication message is sent include one or more of:
one or more child or parent IAB-nodes given a topology of the IAB network,
an IAB-donor (more precisely IAB-donor CU) at the top of the IAB network topology,
a sharing IAB-node sharing the BH radio link with the detecting IAB-node.

For instance, when the change in link conditions is detected by an IAB-mobile termination of the detecting IAB-node, the other IAB-node or nodes to which the indication message is sent include one child IAB-node given a topology of the IAB network.

In another embodiment, when the change in link conditions is detected by an IAB-distributed unit of the detecting IAB-node, the other IAB-node or nodes to which the indication message is sent include one parent IAB-node given a topology of the IAB network.

From the perspective of the above-mentioned routing IAB-node, the method may further comprise, at the routing IAB-node, forwarding the indication message to one or more child IAB-nodes given a topology of the IAB network. This allows propagating the information of the link condition change at the BH radio link, over the IAB network.

In that case, the method may further comprise, at the routing IAB-node, updating link condition information specified within the indication message and relating to an impacted Backhaul Adaptation Protocol, BAP, path involving the BH radio link, based on an evaluated link condition of one of its egress BH radio links. In that way, from one IAB-node to the other, a quality or the like of a BAP path can be refined.

In some embodiments, the method further comprises, at the routing IAB-node, retrieving, from the received indication message, an indication as to whether forwarding the indication message to an IAB-donor of the IAB network or to a sharing IAB-node of the BH radio link or not, and accordingly forwarding the received indication message to the IAB-donor and/or to the sharing IAB-node.

In specific embodiments, the method further comprises, at the routing IAB-node, deleting the IAB-donor forwarding indication from the indication message or messages forwarded to one or more IAB-nodes when the same received indication message is forwarded to the IAB-donor. This aims at avoiding duplicating the same indication message intended to the IAB-donor at each routing IAB-node, hence reducing overload.

As mentioned above, the indication message helps each IAB-node, including the detecting and routing IAB-nodes, to choose more efficient strategies to handle the BAP packets they receive.

In some embodiments, the method further comprises, at the detecting or routing IAB-node, determining one or more impacted Backhaul Adaptation Protocol, BAP, paths involving the BH radio link. For the detecting IAB-node, this may merely consist in using its BH routing configuration tables to identify the paths from the BH radio link concerned by the condition change. For other IAB-nodes, this may merely consist in reading corresponding information from the received indication message.

In exemplary embodiments, the method further comprises, at the detecting or routing IAB-node, buffering received BAP packets that specify one of the impacted BAP paths, until the BH radio link is recovered. Such strategy may be implemented should the information in the indication message specifies for example that the deficiency of the BH radio link is temporary.

In other exemplary embodiments, the method further comprises, at the detecting or routing IAB-node, determining one BAP path alternate to one of the impacted BAP paths and rerouting, over the alternate BAP path, received BAP packets that specify the impacted BAP path. Thanks to the information, the IAB-node can efficiently limit the rerouting to specific BAP packets. This avoids rerouting all BAP packets over the same BAP path and facing risks of service interruption and of network congestion.

In specific embodiments related to such rerouting, the method further comprises, at the detecting or routing IAB-node, updating a BAP routing identifier of the received and rerouted BAP packets to specify the alternate BAP path. This ensures easy processing of these rerouted BAP packets by the IAB-nodes along BAP path being taken.

In yet other exemplary embodiments, the method further comprises, at the detecting or routing IAB-node, stop rerouting received BAP packets that specify one of the impacted BAP paths over an alternate BAP path, and routing back such received BAP packets to the impacted BAP path. It means the information received specifies the impacted BAP path has been recovered. This strategy makes it possible to restore the normal operating state of the IAB network.

In some embodiments relating to the IAB-donor, adapting a routing configuration of IAB-nodes includes withdrawing, from the routing configuration, one or more BAP paths involving the BH radio link when the received indication message indicates a deficiency of the BH radio link. This aims at improving network efficiency when transmitting BAP packets.

In specific embodiments, deciding to withdraw one or more BAP paths involving the BH radio link is further based on the expiry of a timer started upon receiving the indication message indicating a deficiency of the BH radio link and stopped upon receiving a further indication message indicating a recovery of the BH radio link. In that way, the IAB-donor may decide not to modify systematically the routing configuration given the evolving network topology but to wait for determining whether an indication that a deficient BH radio link has been recovered is received, before actually adapting the routing configuration. This provides a smooth routing management, where modification of the routing configuration is made when indeed necessary.

In other embodiments, adapting a routing configuration of IAB-nodes includes reintroducing, in the routing configuration, one or more BAP paths involving the BH radio link when the received indication message indicating a recovery of the BH radio link. In that way, a previous routing configuration within the IAB network may be restored, which usually has better network performance.

As mentioned above, reconfiguration of the IAB-nodes according to a new routing configuration includes for the IAB-donor to send control frames with a view of providing new (or modified or updated) BH Routing Configuration tables to some or each IAB-node.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a communication system in which the present invention may be implemented according to one or more exemplary embodiments;

FIG. 2 schematically illustrates stacks of some protocol layers involved into IAB operations;

FIG. 3 illustrates the format of a BAP Protocol Data Unit (PDU) or packet;

FIG. 4 illustrates the routing management in an IAB network;

FIG. 5 illustrates routing tables in IAB-nodes according to 3GPP TS 38.300 and TS 38.340;

FIG. 6 illustrates the format of a BH RLF indication as specified in the standardized version paragraph 6.2 of 3GPP TS38.340 release 16.1.0;

FIG. 6a illustrates an exemplary format of the Control PDU for BH RLF indication according to embodiments of the invention;

FIG. 7 illustrates an example of IAB network topology presenting network path diversity in which the present invention may be implemented according to one or more exemplary embodiments;

FIG. 8 illustrates, using a flowchart, general operations at a detecting IAB-node, according to embodiments of the invention;

FIG. 9 illustrates, using a flowchart, general operations at a routing IAB-node when receiving a BH RLF Indication message, according to embodiments of the invention;

FIG. 10 illustrates, using a flowchart, general operations at the IAB-Donor when receiving a BH RLF Indication message, according to embodiments of the invention; and

FIG. 11 shows a schematic representation of a wireless communication device in accordance with embodiments of the present invention.

### DETAILED DESCRIPTION OF EMBODIMENTS

In an Integrated Access and Backhaul, IAB, network, an IAB-node detects a deficiency of one of its BH radio links, such as a radio link failure. A BH RLF indication message can be sent to its child IAB-nodes specifying the BAP paths that are impacted, a quality or congestion level of those paths and possibly the deficient radio link by indicating the other (sharing) IAB-node sharing the link. Same message can be transmitted to this sharing IAB-node, but also to the IAB-donor of the network in order to contemplate adapting the configuration of the IAB-nodes to the new network topology. BAP packets for the impacted BAP paths can be rerouted using alternative BAP paths. IAB-nodes receiving the BH RLF indication message can also apply routing strategies for the impacted BAP paths, taking into account the indicated quality or congestion level. A similar message may be transmitted when the BH radio link experiences recovery, so that the IAB-nodes can stop rerouting the BAP packets and the IAB-donor can restore the original configuration.

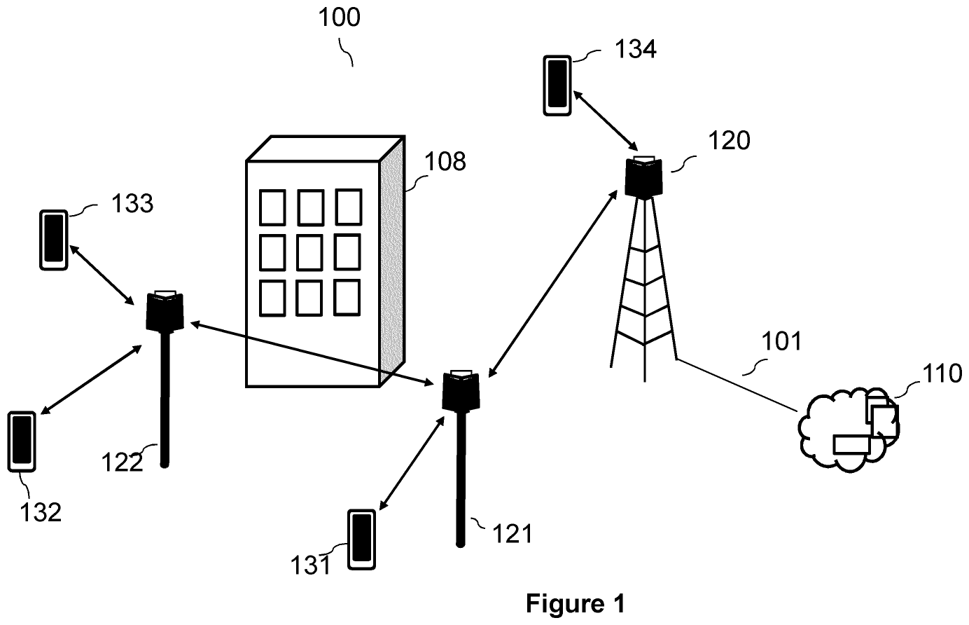

FIG. 1 illustrates a communication system 100 in which the present invention may be implemented according to one or more exemplary embodiments.

As depicted, the exemplary system 100 is a wireless communication system, in particular a mobile radio communication system such as a fifth-generation (5G) New Radio (NR) system.

The system 100 comprises a plurality of UEs (User Equipment) 132, 133, 131 and 134, a remote core network 110, a main Base Station 120, and two Integrated Access and Backhaul (IAB) stations 121 and 122.

The main Base Station 120, also referred to as the IAB-donor 120, is connected to the core network 110 through a wired link 101, preferably an optical fiber or any other wired means. In one embodiment, IAB-donor 120 is a 5G NR gNB with additional functionality to support IAB features, as defined in 3GPP TS 38.300 v16.2.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120.

The IAB-donor 120 also serves UE 134, which is directly connected to it.

The IAB-donor 120 and the IAB-stations 121 and 122 are thus forming a backhaul network, which accommodates UEs 132, 133, 131 and 134.

The specification of the Integrated Access and Backhaul (IAB) is spread over several 3GPP standard documents, including:
TS 38.300 RAN architecture (V16.2.0),
TS 38.321 MAC protocol (V16.1.0),
TS 38.331 Radio Resource Control (RRC) protocol (V16.1.0),
TS 38.340 Backhaul Adaptation Protocol Layer (V16.1.0),
TS 38.401 RAN architecture (V16.2.0),
TS 38.473 F1 Application Protocol (V16.2.0).

As IAB-nodes 121 and 122 are respectively connected to UEs 131, 132 and 133, they are considered as Access IAB-nodes for their respectively connected UEs.

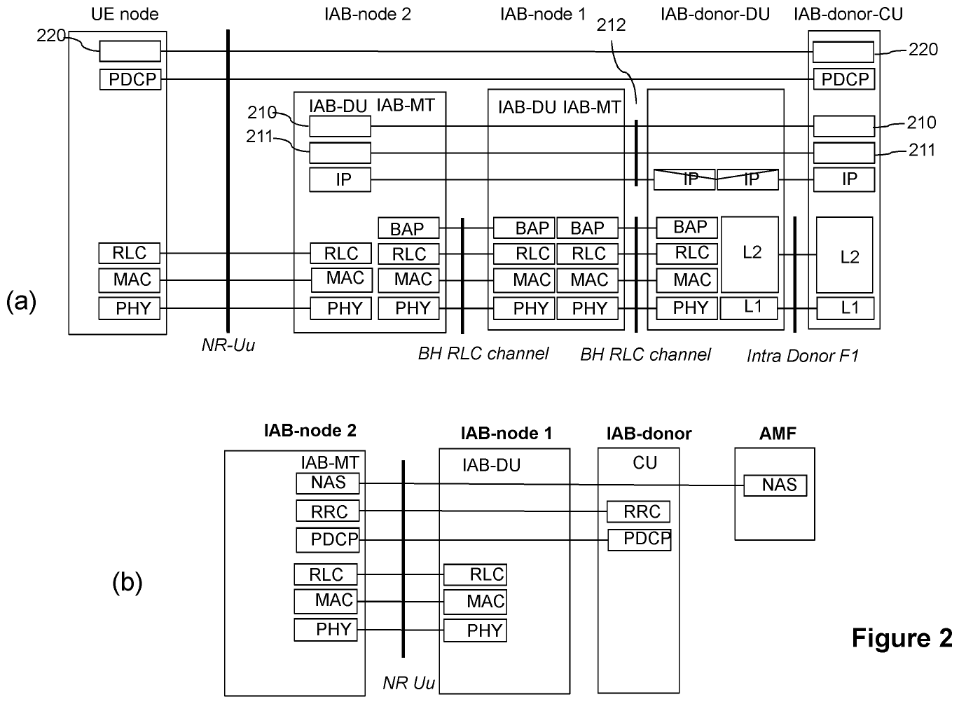

The IAB-donor 120 is a logical node that provides the NR-based wireless backhaul and consists of a central unit (CU or gNB-CU functionality) and connected donor distributed unit(s) (DU or gNB-DU functionality). The IAB-donor CU and IAB-donor DU may be located far from the other. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIG. 2 discussed below.

The IAB nodes, which may serve multiple radio sectors, are wireless backhauled to the IAB-donor 120, via one or multiple hops. They form a directed acyclic graph (DAG) topology with the IAB-donor at its root.

Each IAB node consists of an IAB-DU and an IAB-MT (IAB-Mobile Termination). The gNB-DU functionality on an IAB-node is also referred to as IAB-DU and allows the downstream (toward the UE) connection to the next-hop IAB. The IAB-MT functionality includes, e.g., physical layer, layer-2, RRC and Non Access Stratum (NAS) functionalities to connect to the gNB-DU of an upstream IAB-node (including the IAB-donor 120 in which case the IAB-MT connects to the IAB-donor DU, hence to the IAB-donor gNB-CU and the core network 110, for instance for initialization, registration and configuration).

In this DAG topology, the neighbour node on the IAB-DU's interface is referred to as child node or child IAB-node, and the neighbour node on the IAB-MT's interface is referred to as parent node or parent IAB-node. The direction toward the child node is further referred to as downstream while the direction toward the parent node is referred to as upstream.

The IAB-donor 120 performs centralized resource, topology and route management for the whole IAB network topology. This includes configuring the IAB-nodes according to the network topology, e.g. in order to perform appropriate routing of data.

FIGS. 2a and 2b schematically illustrate stacks of some protocol layers involved into IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor CU and an IAB-node DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node1 and then from IAB-node1 to IAB-node2).

In the User Plane, boxes 210 at the IAB-donor CU and the IAB-node DU refer to the GTP—U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor CU and the IAB-node DU. The well-known User Datagram Protocol (UDP) is a transport layer protocol providing a best effort datagram service and fit to use with an IP protocol.

In the Control Plane, boxes 210 indicate the F1AP (F1 Application Protocol) layer and boxes 211 Indicate the SCTP (Stream Control Transmission Protocol) layer. The F1 Application Protocol (as defined in 3GPP TS38.473 and TS 38.401) provides signalling services between the IAB-donor CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor CU and the IAB-node DU as defined in 3GPP TS 38.401.

The transport between the IAB-donor DU and the IAB-donor CU also uses an IP transport Layer over various media, like for example wires or optical fiber when the IAB-donor CU is remote from the IAB-donor DU, or locally in a virtual instantiation of the IAB-donor CU and the IAB-donor DU on the same physical machine. IAB-specific transport between IAB-donor-CU and IAB-donor-DU is specified in 3GPP TS 38.401.

L1 and L2 on the Figure stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

In downstream direction, upper layer packets are encapsulated by the BAP sublayer at the IAB-donor DU, thus forming BAP packets or data units. The BAP packets are routed by the BAP layer (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended to a UE).

In upstream direction, upper layer packets are encapsulated by the BAP sublayer at an initiator IAB-node (which may be an access IAB-node should the upper layer packets come from a UE), thus forming BAP packets or data units. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

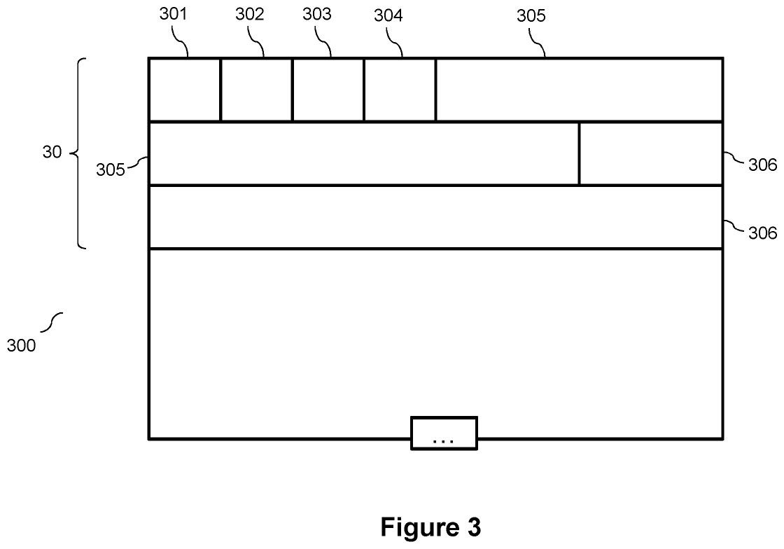

On the BAP sublayer, packets are routed based on a BAP routing ID, which is carried in the BAP header of the BAP packets and is set by the BAP sublayer of the emitting IAB-donor DU or initiator IAB-node. FIG. 3 illustrates the format of a BAP Data Protocol Data Unit (PDU) or packet. It is specified in the standardized version paragraph 6.2 of 3GPP TS38.340 release 16.1.0.

The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).
Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor DU for the BAP packet. For the purpose of routing, each IAB-node and IAB-donor DU is configured (by IAB-donor CU) with a designated BAP address.

Field 306 carries a path ID identifying the routing BAP path the BAP packet should follow to this destination in the IAB topology. For the purpose of routing, the BAP paths, including their path ID, are configured (by IAB-donor CU) in the IAB-nodes.

The BAP header is added to the packet when it arrives from upper layers to the BAP layer, and it is stripped off by the BAP layer when it has reached its destination node. The selection of the packet's BAP routing ID is configured by the IAB-donor CU.

For instance, when the BAP packet is generated by an IAB-node, i.e. either by the IAB-donor for downstream transmission or by an initiator IAB-node for upstream transmission, the BAP header with the BAP Routing ID is built by this IAB-node according to a configuration table defined in 3GPP TS 38.340. This table is called Downlink Traffic to Routing ID Mapping Configuration table in the IAB-donor or Uplink Traffic to Routing ID Mapping Configuration table in the initiator IAB-node. In intermediate IAB-nodes, the BAP header fields are already specified in the BAP packet to forward.

As mentioned above, these tables defining the BAP paths (hence the routing strategy and the configuration of the IAB-nodes given the IAB network topology) are usually defined by the IAB-donor CU and transmitted to the IAB-nodes to configure them.

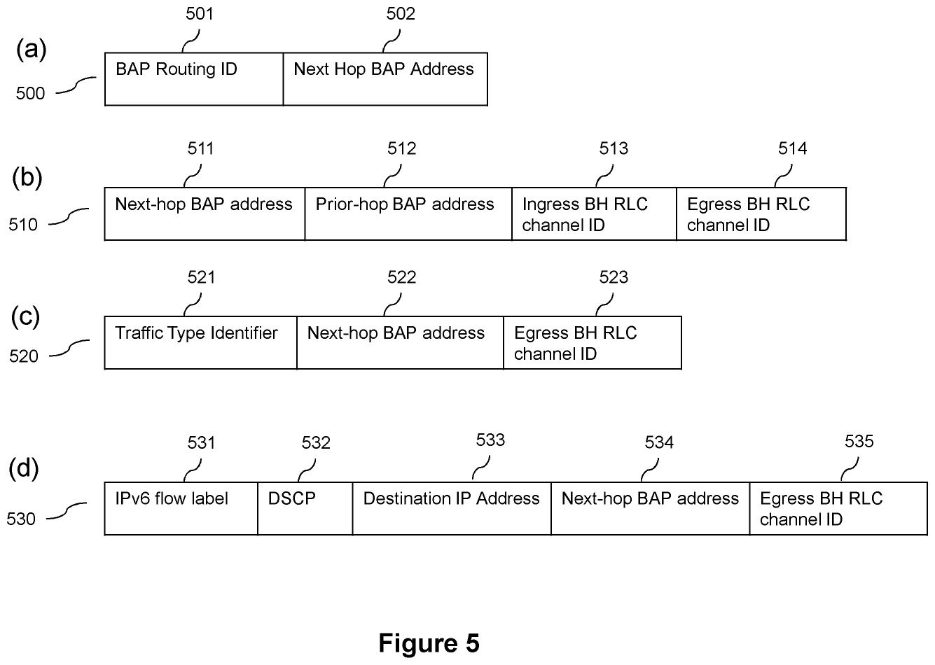

A usage of these tables (and other tables) to perform the routing is described below with reference to FIG. 5.

To transport messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter side, The MAC encapsulates the data packet issued from the RLC. It adds a header carrying information necessary to the MAC function. On the receiver side, The MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at emitter side; at receiver side it converts the physical modulation signals back to a stream of information. The PHY layer is described in TS 38.201, TS 38.211, TS 38.212, TS 38.213, TS 38.214.

To pass messages towards the user or control plane, two other sublayers are used in UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS38.323.

SDAP sublayer 220 for the User Plane handles the Quality of Service. It is described in TS38.324. On the UE side, the SDAP sublayer exchanges the payload data with the user's application (voice, video, etc.—not shown in the Figure). On the IAB-donor side, the SDAP sublayer exchanges the data with the Core Network 110 (Internet traffic, Cloud, etc.).

RRC sublayer 220 for the Control Plane handles the configuration of the protocol entities of the User Plane protocol stack. It is described in TS38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 v16.2.0 and illustrates the protocol stack for the support of IAB-MT's RRC and NAS connections. The Non-Access Stratum (NAS) protocol handles the messages between the core network and a user equipment, or an IAB-node. It manages the establishment of communication sessions and maintains communications with the IAB-node or the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information proper to the IAB-node. AMF is only responsible for handling connection and mobility management tasks.

The IAB-MT establishes signalling Radio Bearers SRBs (bearers carrying RRC and NAS messages) with the IAB-donor-CU. These SRBs are transported between the IAB-MT and its parent node(s) over NR-Uu interface(s).

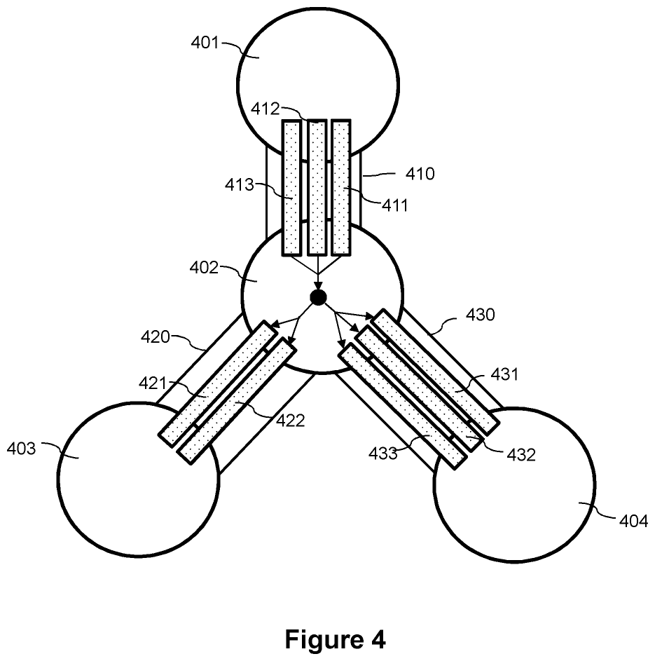

FIG. 4 illustrates a routing management in an IAB network. The routing management at an IAB-node acting as relay is based on a BAP routing configuration and seeks to determine, from one BH RLC channel of an ingress link over which a BAP packet is received, one BH RLC channel of one egress link for forwarding the received BAP packet.

A BAP routing configuration may be set manually in each IAB-node of the IAB network. Preferably, the BAP routing configurations are built and can be updated over time by IAB-donor CU and transmitted by same via F1AP signalling to the IAB-nodes during their initial configurations and the life of the IAB network. As mentioned above, the BAP routing configurations may be built by IAB-donor CU based on the IAB network topology and its evolution over time (e.g. should some radio links disappearing or recovering or their link quality changing).

The BAP routing configuration of the IAB-node comprises various routing tables, four of which are shown in FIG. 5.

FIG. 5a schematically shows an entry 500 of the Backhaul Routing Configuration table as defined in 3GPP TS 38.300, V16.2.0, section 6.11.3 for the BAP sublayer. It is used by the IAB-node to select the egress link to forward or transmit a BAP packet or PDU (Protocol Data Unit).

Field 501 defines a BAP Routing ID (concatenation of the PATH and DESTINATION fields mentioned above) while field 502 specifies the next-hop BAP Address, i.e. the BAP address of the next IAB-node along the path corresponding to the Routing ID 501. The Next Hop BAP address 502 thus identifies an egress link to forward or transmit the BAP packet.

There may be several entries in the Backhaul Routing Configuration table with the same destination BAP address but with different Path IDs and next-hop BAP Addresses in the information element 502. The first entry may provide the default next-hop BAP Address corresponding to the default path to reach the destination, and the other entries with the same destination BAP address relate to back-up redundant paths to be selected when the default link is not available, e.g. because of radio link failure (RLF).

FIG. 5b schematically shows an entry 510 of the BH RLC channel mapping configuration table as defined in 3GPP TS 38.300, section 6.11.3 and/or 3GPP TS 38.340, V16.1.0, section 5.2.1.4.1, for the BAP sublayer. It is used by the IAB-node acting as a relay to identify the Backhaul (BH) RLC channel where to forward a BAP packet or PDU over the egress link previously selected using the Backhaul Routing Configuration table.

Information Element (IE) 511 stores a next-hop BAP address as defined previously and usually obtained from the Backhaul Routing Configuration table; IE 512 stores a prior-hop BAP address, i.e. the BAP address of the previous IAB-node from which the BAP packet to route arrives; IE 513 specifies an ingress RLC channel ID, i.e. the identifier of an RLC channel over which the BAP packet to route is received; and IE 514 stores an egress RLC channel ID providing the RLC channel the IAB-node will use to forward the BAP packet.

Note that for BH RLC channels in downstream direction (parent to child direction, e.g. IAB-node 402 towards IAB-node 403 in FIG. 4), the BH RLC channel ID is included in the F1AP configuration of the BH RLC channel. For BH RLC channels in upstream direction (child to parent direction, e.g. IAB-node 402 towards IAB-node 401), the BH RLC channel ID is included in the RRC configuration of the corresponding logical channel.

FIGS. 5c and 5d illustrates the equivalents to the BH RLC channel mapping configuration table for the IAB-node that does not act as intermediate IAB relaying entities. They are defined in 3GPP TS 38.340, sections 5.2.1.4.2. and section 5.2.1.4.3.

The table in FIG. 5c is called Uplink Traffic to BH RLC Channel Mapping Configuration table, 520. It is used by an initiator IAB-node (not the IAB-donor) having built BAP packets or PDUs from BAP SDUs (Service Data Unit) received from upper layers, to identify the Backhaul (BH) RLC channel to transmit these packets in upstream direction over the egress link previously selected using the Backhaul Routing Configuration table described in FIG. 5a.

IE 521 specifies a Traffic Type Identifier for the SDUs received from the upper layers, IE 522 indicates a next-hop BAP address as defined previously and usually obtained from the Backhaul Routing Configuration table, and IE 523 specifies an egress BH RLC channel providing the RLC channel the IAB-node will use to transmit the BAP packet.

The table in FIG. 5d is called Downlink Traffic to BH RLC Channel Mapping Configuration table 530. It is used by the IAB-donor having built BAP packets or PDUs from BAP SDUs (Service Data Unit) received from upper layers, to identify the Backhaul (BH) RLC channel to transmit these BAP packets in downstream direction over the egress link previously selected using the Backhaul Routing Configuration table.

IE 531 is an IPv6 flow label used to classify IPv6 flows, IE 532 specifies a DSCP (Differentiated Services Code Point) usually indicated in the IPv6 header of the packets, IE 533 indicates a destination IP Address, IE 534 indicates a next-hop BAP Address as defined above, and IE 535 defines an egress BH RLC channel ID providing the RLC channel the IAB-node will use to transmit the BAP packet.

The tables of FIGS. 5b, 5c and 5d may be composed of several rows (entries), each row/entry including the IEs shown in the respective Figures.

Next-hop BAP address and egress link are synonymous because they designate the same portion (radio link) of the IAB network between the current IAB-node and the next IAB-node having the next-hop BAP address. Consequently, they can be used indifferently to designate such IAB network radio link.

Thanks to all the tables configured in the IAB-nodes and more particularly the Routing IDs of IEs 501, multiple BAP paths are defined between multiple IAB-nodes.

Back to FIG. 4, the routing of a BAP packet by the BAP sublayer of IAB-node 402 uses the BAP routing ID 305+306 of a BAP packet. The BAP address (DESTINATION path 305) is used for the purpose of:

1) determining whether the BAP packet has reached the destination node, i.e. IAB-node or IAB-donor DU, on BAP sublayer. The BAP packet has reached its destination node if the BAP address 305 in the packet's BAP header matches the BAP address configured either via RRC on the IAB-node or via F1AP on the IAB-donor DU.

2) determining the next-hop IAB-node for the BAP packet that has not reached its destination. This applies to BAP packets arriving from a prior-hop IAB-node over the BAP sublayer or arriving from upper layers.

For packets arriving from a prior-hop IAB-node or from upper layers, the determination of the next-hop IAB-node is based on the entries 500 of the Backhaul Routing Configuration table.

The IAB-node 402 resolves the next-hop BAP address 502 to a physical backhaul link, being either link 420 or link 430. To that end, it seeks the entry 500 in the table having field 501 matching the BAP Routing ID 305+306 of the BAP packet. Corresponding field 502 provides the next-hop BAP address.

The Backhaul Routing Configuration table may have multiple entries 500 with different BAP Routing IDs but with the same destination BAP address (meaning the BAP Path IDs are different). These entries may correspond to the same or different egress BH links. In case, the BH link matching the BAP Routing ID of the BAP packet experiences a radio link failure (RLF), the IAB-node may select another egress BH link (next-hop BAP address) based on routing entries with the same destination BAP address, i.e. by disregarding the BAP path ID. In this manner, a BAP packet can be delivered via an alternative path in case the indicated path is not available.

For instance, in case BH link 420 experiences a radio link failure, IAB-node 402 may select another BAP routing ID having the same destination BAP address but involving BH link 430 instead.

Next, the IAB-node 402 derives the egress BH RLC channel of the selected egress BH link, over which the BAP packet is to be transmitted or forwarded. To that end, the IAB-node 402 uses the BH RLC channel mapping configuration table or Uplink Traffic to BH RLC Channel Mapping Configuration table or Downlink Traffic to BH RLC Channel Mapping Configuration table depending on its role (intermediate relay IAB-node, initiator IAB-node or IAB-donor transmitting in uplink or downlink direction) For instance, for an intermediate relaying IAB-node, IEs 511, 512, 513 are the inputs and IE 514 is the output of the BH RLC channel look-up process: IAB-node 402 routes the incoming BAP packets received from the ingress BH RLC channel ID 513, belonging to the ingress BH link identified by the prior-hop BAP address 512, to the egress BH RLC channel ID 514, belonging to the egress BH link previously selected and now identified by the next-hop BAP address 511.

For an initiator IAB-node wishing to transmit a BAP packet in upstream direction to the IAB-donor, IEs 521, 522 are the inputs and IE 523 is the output of the BH RLC channel look-up process: the IAB-node 402 selects the egress BH RLC Channel 523 corresponding to the table entry 520 where the Traffic Type Identifier 521 matches the traffic type of the original BAP SDU, and where the next-hop BAP address 522 matches the next-hop BAP address previously selected with the Backhaul Routing Configuration table. This applies for BAP SDUs in the control plane (non F1-U packets), as well as for BAP SDUs in the user plane (F1-U packets). The Traffic Type Identifier 521 shall correspond to the destination IP address and TEID (Tunnel End Point Identifier) of the BAP SDUs.

For the IAB-node (possibly IAB-donor) wishing to transmit a BAP packet in downstream direction to a destination IAB-node or an UE, IEs 531, 532, 533, 534 are the inputs and IE 535 is the output of the BH RLC channel look-up process: IAB-node selects the egress BH RLC Channel 535 corresponding to the table entry 530 matching the Destination IP address 533, the IPv6 Flow Label 531 (only for BAP SDU encapsulating an IPv6 packet), and the Differentiated Services Code Point (DSCP) 532 of the original BAP SDU, and where the next-hop BAP address 534 matches the next-hop BAP address previously selected with the Backhaul Routing Configuration table. This applies for BAP SDUs in the control plane (non F1-U packets), as well as for BAP SDUs in the user plane (F1-U packets).

In any case, if there is no matching entry, a default BH RLC ID channel is selected.

Such routing process can be implemented in the various IAB-nodes of an IAB network.

As mentioned above, BH radio link failure (RLF) on a BH radio link can be detected by a detecting IAB-node, such as IAB-node 402, to select another BAP Routing ID (e.g. another BAP path over another radio link) if existing.

RLF detection can be performed using conventional mechanisms, such as monitoring a state of the radio links through the periodic exchanges of signals at the PHY layer with the connected IAB-nodes (e.g. to tune antennas, negotiate radio power, and so on).

3GPP TS 38.340 of the release 16 for 5G NR introduced BH RLF indication messaging in which the detecting IAB-node (experiencing the RLF) notifies its child IAB-nodes, e.g. IAB-nodes 403 and 404, of its failure to recover from RLF.

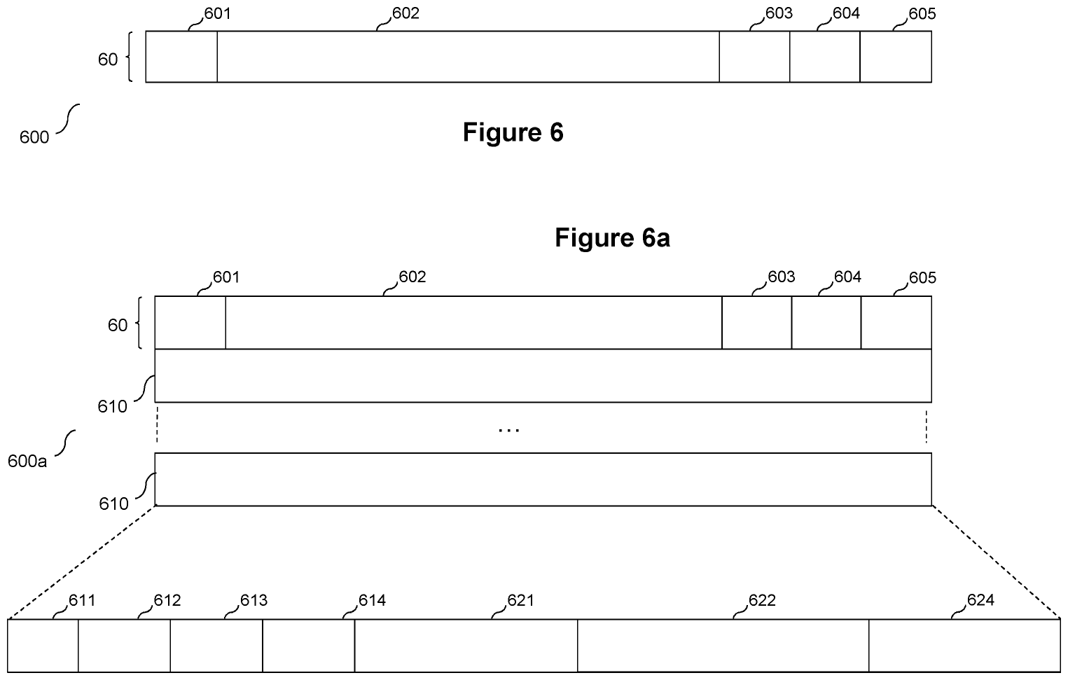

FIG. 6 illustrates the format of a BH RLF indication. It is a Control PDU for BH RLF indication 600 as specified in the standardized version paragraph 6.2 of 3GPP TS38.340 release 16.1.0.

It is made of a one-byte header 60 comprising fields 601 to 605. Field 601, named D/C field, is a Boolean indicating whether the corresponding BAP packet is a BAP Data packet or a BAP Control packet. This bit is set to ‘0’ for BH RLF indication Control PDU 600.

Field 602 indicates the type of control information included in the corresponding BAP Control PDU 600. Paragraph 6.3.7 of 3GPP TS38.340 release 16.1.0 requests that this field be set to the “0011” value to indicate network change, here a BH RLF.

Fields 603-605 are one-bit reserved fields, preferably set to 0 (to be ignored by the receiver).

Upon receiving a Control PDU for BH RLF indication 600, a child IAB-node may perform a BH link re-establishment, which means connecting to a different parent IAB-node.

In the example of FIG. 4, IAB-node 402 detects a radio link failure for link 410 with IAB-node 401 and fails to recover it from RLF. It thus sends a Control PDU for BH RLF indication 600 (here below “BH RLF indication”) to its child IAB-nodes. Child IAB-node 403 receiving the BH RLF indication 600 infers IAB-node 402 is no longer reliable (which is the case here since IAB-node has only one upstream radio link) and then establishes another connection to a different parent IAB-node (not shown). Next, IAB-node 403 may reroute all received upstream BAP packets to the new parent IAB-node rather than to IAB-node 402. Child IAB-node 404 may proceed in the same way, connecting to another new parent IAB-node.

The BH RLF indication 600 can also be forwarded by a child IAB-node to its own child IAB-nodes, with a view of taking similar measures.

This situation is however not satisfactory to have an efficient IAB network.

For instance, the BH RLF indication only reports radio link failure, i.e. when a BH radio link can no longer be used. The IAB-nodes receiving the BH RLF indication thus systematically try to reestablish a connection with a different parent IAB-node. However, it would be helpful to report a graduated level of failure or deficiency. This would help the IAB-nodes to take appropriate decisions as to find a new parent IAB-node or not, hence to find or not alternative BAP paths.

Also, the above systematic reestablishment results in having all the BAP packets rerouted to the same new parent IAB-node. However, this strategy introduces an interruption of service and increases the risks of network congestion.

It would therefore be beneficial to have an enhanced BH RLF indication that allows more efficient network and routing management.

It is thus proposed that a change in link conditions be detected for one of the BH radio links, and the resulting BH RLF indication indicates a detected link condition change in the IAB network (as in the prior art) and further provides information relating to this BH radio link. This additional information is specific to the changing radio link, allowing the child IAB-nodes to take reasoned decisions as to the reestablishment and/or the rerouting of received BAP packets, in particular to decide to adapt the routing of the BAP packets between routing over an impacted BAP path involving the BH radio link and routing over an alternate BAP path.

Should the IAB-donor also receive the BH RLF indication, it may then decide to adapt a routing configuration of IAB-nodes (i.e. the routing tables) to the new topology of the IAB network, in particular to optimize the BAP paths that are impacted by the link condition change at the BH radio link. The BH RLF indication thus preferably includes a field signalling whether the message is to be forwarded to the IAB-donor of the IAB network or not.

For illustrative purpose, exemplary information may signal whether the condition change mirrors a radio link deficiency or a radio link recovery, and/or may include the path ID of one or more BAP paths impacted by the link condition change at the BH radio link (either in deficiency or in recovery), and/or may include a quality level for the link (e.g. radio link quality or congestion level) or for one or more signalled impacted BAP paths, and/or an identifier (e.g. BAP address) of the sharing IAB-node sharing the BH radio link experiencing the condition change.

The BH radio link for which a link condition change is detected (either a deficiency/failure or a recovery) is referred as to “changing radio link”.

FIG. 6a illustrates an exemplary format of the Control PDU for BH RLF indication according to embodiments of the invention. The BH RLF indication 600a includes the same header 60 as described above with reference to FIG. 6.

It further includes one or more concatenated fields 610, referred to as BH RLF Indication entries.

In one embodiment, the RLF Indication entry 610 is made of fields 611 to 624.

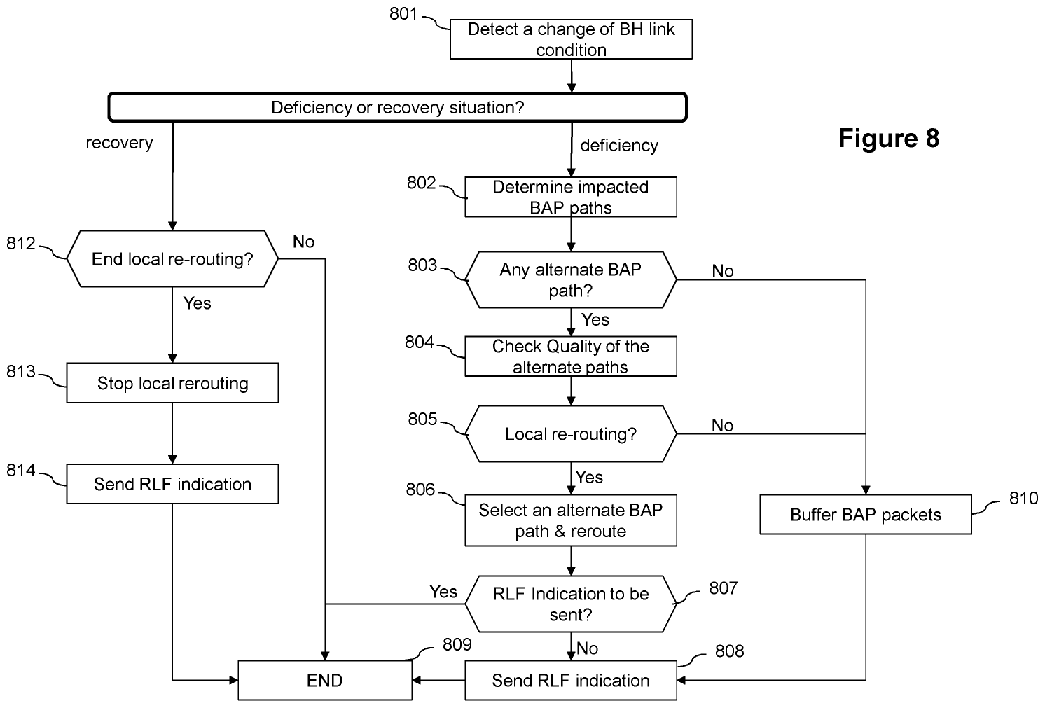

Fields 611 and 621 are used together to signal one impacted BAP path involving the changing BH radio link experiencing the detected link condition change. In this embodiment, each RLF Indication entry is thus associated with an impacted BAP path. Determination of the impacted BAP paths is described below with reference to the process of FIG. 8 for instance.

1-bit field 611 indicates (when enabled, i.e. set to ‘1’) the presence of the Path ID field 621 in the RLF Indication Entry 610. Path ID field 621 specifies the impacted BAP path, for instance using its Path ID, i.e. the PATH value. In one embodiment, field 621 is a Routing ID (similar to fields 305 and 306 of FIG. 3), which includes a Path ID.

Fields 612 and 622 are used together to signal link condition information relating to the impacted BAP path of the RLF Indication entry 610.

1-bit field 612 indicates (when enabled) the presence of the Quality field 622 in the RLF Indication Entry 610. Quality field 622 specifies the information (below Quality information) representative of a link condition of the associated impacted BAP path (indicated in field 621). It may be representative of a radio quality of the entire BAP path, and/or of a congestion level over the BAP path, or of a value weighting both radio quality and congestion level. It may also be formed of two separate values: the radio quality and the congestion level.

The Quality information (quality or congestion) for a given BAP path may be estimated by the detecting IAB-node as follows: initial Quality information is known (for instance obtained from another IAB-node or predefined to correspond to an initial and operative state of the IAB network) that corresponds to a condition state of the changing radio link belonging to the BAP path; the IAB-node detects a condition change at the radio link (either an improvement or a decreasing); an estimate of the radio link quality and/or congestion level change is obtained; the initial Quality information is thus updated based on the estimated radio link quality and/or congestion level change to mirror the new condition state of the radio link.

To ease signalling, the Quality information may be defined as an integer within a predefined range, e.g. 0 to 2ₙ−1.

Field 613 is used alone to indicate whether all or part of the information embedded in the RLF Indication Entry 610 (and thus in the BH RLF indication Control PDU 600a) should be forwarded to the IAB-Donor CU by any IAB-node receiving the BH RLF indication 600a. It may be a single bit.

Fields 614 and 624 are used together to indicate or signal the sharing IAB-node sharing the changing BH radio link with the detecting IAB-node. As explained below, this signalling is used to warn this sharing IAB-node of the condition change situation, so that it can take measures regarding the management of BAP packets (e.g. routing) to be normally conveyed over the impacted BAP paths.

1-bit field 614 (when enabled) indicates the presence of the Sharing Address field 624 in the RLF Indication Entry 610. Sharing Address field 624 carries the BAP address of the sharing IAB-node for the changing BH radio link. In case of a downstream communication (i.e. from the Donor-CU to an access IAB-node), Sharing Address field 624 is set to the BAP address of the parent IAB-node for the changing BH link. In case of an upstream communication (i.e. from an access IAB-node to the Donor-CU), Sharing Address field 624 is set to the BAP address of the child IAB-node for the changing BH link.

This embodiment thus provides the RLF Indication Entry 610 made of all the fields 611 to 624. Of course, one or more of fields 621, 622, 624 may be empty if the corresponding field 611, 612, 614 is disabled (i.e. set to ‘0’). The fields that are filled in may be different from one RLF Indication Entry 610 to the other, within the same BH RLF Indication 600a.

In some embodiments, only part of these fields may be provided in an RLF Indication Entry 610, for instance any combination of the fields 613, 621 (+611), 622 (+612) and 624 (+614).

If field 621 (+611) is not present, it means that the RLF Indication Entry 610 is not associated with a BAP path, but provides information directly about the changing RH radio link. Therefore, a single RLF Indication Entry 610 is preferably provided within the BH RLF Indication 600a. In this case, the Quality field 621 may be representative of a radio quality of the changing BH radio link (and no longer of a BAP path), or of a congestion level of the changing radio link, or of a combination of both radio link quality and link congestion level, or of a confidence level of recovery from a radio link failure of the BH radio link. The confidence level for link recovery may be determined by the detecting IAB-node based on history data, by searching for similar historical situations of link deficiency and inferring a chance that the radio link be recovered in a reasonable time limit.

In one embodiment of the invention, the RLF Indication Entry 610 is made of Path ID field 621 only. Thus, multiple RLF Indication Entries may be provided within the same BH RLF Indication 600a to signal multiple impacted BAP paths. The IAB-nodes receiving the BH RLF Indication 600a thus have only to manage the BAP packets exchanged over the BAP path or paths identified in the Entries 610.

In one embodiment of the invention, the RLF Indication Entry 610 is made of Quality field 622 only. As mentioned above, the Quality information is provided for the changing BH radio link only. The child IAB-nodes receiving the BH RLF Indication 600a thus knows the decrease or increase of link conditions at their parent IAB-node, and can therefore take appropriate measures to reroute or stop rerouting received BAP packets.

In one embodiment of the invention, the RLF Indication Entry 610 is made of Sharing Address field 624 only. This makes it possible to efficiently warn the sharing IAB-node for it to adapt its routing of BAP packets.

Of course, the RLF Indication Entry 610 may be let empty, in which case the BH RLF Indication 600a may be similar to the conventional BH RLF Indication 600.

Where the RLF Indication Entry 610 is associated with an impacted BAP path, there may be multiple entries 610 within the same BH RLF Indication 600a, respectively associated with multiple impacted BAP paths. In order to signal there is no more entry 610 in 600a, a last and additional RLF Indication Entry 610 may have fields 611, 612, 613 and 614 (or those of the field combination considered) set to ‘0’.

In some embodiments, RLF Indication Entries 610 may also be used to signal the BAP paths that are not impacted (i.e. concerned by the changing BH radio link) at the detecting IAB-node. For instance, an additional 1-bit field (not shown) may then be provided in each entry 610 to further indicate whether the associated BAP path is impacted or not by the declared link condition change.

In these various embodiments of Control PDU for BH RLF Indication 600a, field 602 is set to “0011” as defined in 3GPP TS38.340 release 16.1.0. The difference between radio link deficiency (including failure) and radio link recovery may be inferred by any IAB-node (receiving the BH RLF Indication 600a) from the Quality field or fields 622. In some embodiments, field 602 may be used to distinctly signal whether the BH RLF Indication 600a signals a radio link deficiency (including failure) or a radio link recovery. Value “0011” may be kept to signal a radio link deficiency, while a new value (taken from the reserved values 0100-1111) may be used to signal a radio link recovery. This may be helpful for instance when no Quality field 622 is provided, but only a list of impacted BAP paths.

The example of FIG. 6a thus discloses a Control protocol data unit, PDU, for backhaul, BH, radio link failure, RLF, indication including a one-byte header, a field of which taking a value indicating a detected link condition change in an Integrated Access and Backhaul, IAB, network, wherein the Control PDU further includes additional information relating to a BH radio link concerned by the link condition change.

In particular, the additional information may include one or more RLF Indication entries associated with one or more respective BAP paths.

Possible options for the various fields of the header and the additional information (including the RLF Indication entries) are described above.

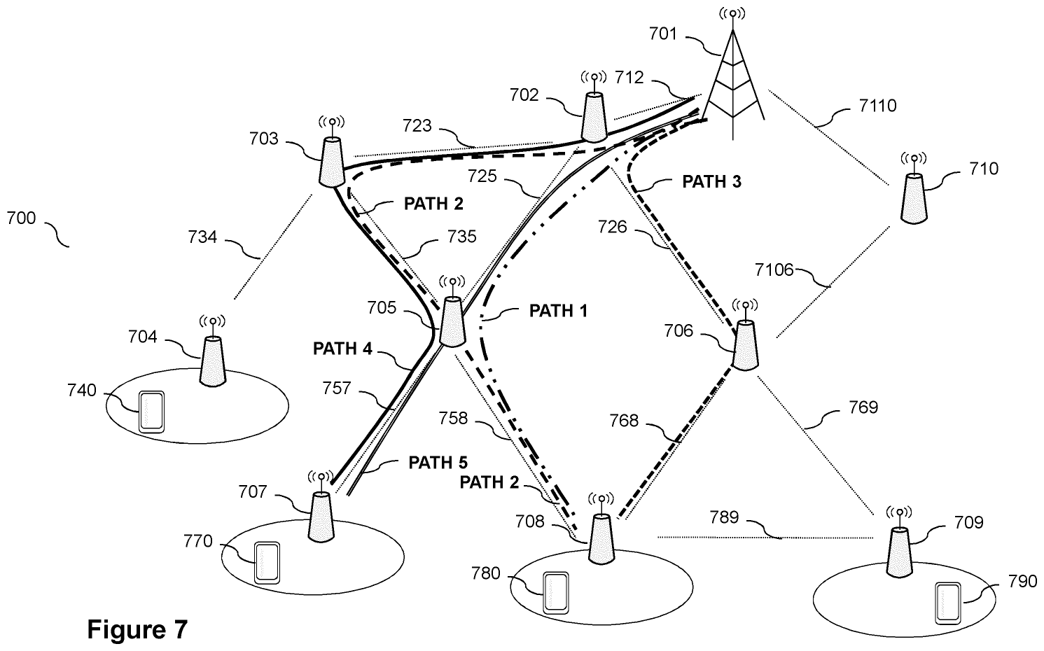

FIG. 7 illustrates an example of IAB network topology presenting network path diversity. In one embodiment, the BH radio are operated over the millimeter wave frequency band (i.e. above 30 GHz), which is highly sensitive to radio channel disturbance.

IAB BH network 700 is made of one IAB-donor 701, similar to IAB-donor 120, and a plurality of IAB-nodes 702, 703, 704, 705, 706, 707, 708 and 709, similar to IAB-nodes 121 and 122. These IAB-nodes are connected through BH links 712, 7110, 723, 725, 726, 734, 735, 757, 758, 768, 769, 789 and 7106.

As IAB-nodes 704, 707, 708 and 709 are respectively serving UEs 740, 770, 780 and 790, they also act as access IAB-nodes for the respective UEs.

Redundant paths may exist between pairs of IAB-nodes, for instance, regarding paths from IAB-donor 701 to IAB-node 708, a first default BAP path via IAB-nodes 702, 705 and 708, a second BAP path that involves IAB-nodes 702, 703, 705 and 708, and a third BAP path that involves IAB-nodes 702, 706 and 708.

For the exemplary description below, we consider the following upstream BAP paths, being noted that downstream BAP paths may also be defined for routing downstream BAP packets from IAB-Donor 701:
PATH 1, associated with Routing ID 1, which connects IAB-node 708 to IAB-Donor 701 via IAB-nodes 705, 702 and goes through BH radio links 758, 725 and 712. This may be the default path between 701 and 708;
PATH 2, associated with Routing ID 2, which connects IAB-node 708 to IAB-Donor 701 via IAB-nodes 705, 703, 702 and goes through BH radio links 758, 735, 723 and 712;
PATH 3, associated with Routing ID 3, which connects IAB-node 708 to IAB-Donor 701 via IAB-nodes 706, 702 and goes through BH radio links 768, 726 and 712;
PATH 4, associated with Routing ID 4, which connects IAB-node 707 to IAB-Donor 701 via IAB-nodes 705, 703, 702 and goes through BH radio links 757, 735, 723 and 712. This may be the default path between 701 and 707;
PATH 5, associated with Routing ID 5, which connects IAB-node 707 to IAB-Donor 701 via IAB-nodes 705, 702 and goes through BH radio links 757, 725 and 712.

BH radio link 725 between IAB-nodes 702 and 705 may experience radio link deficiency due to some unexpected interference or shadowing phenomena, for example radio link failure, RLF. The default BAP path PATH 1 may thus become unavailable between IAB-nodes 701 and 708. Only the second and third paths, PATH 2 and PATH 3, may then be used. As explained above, IAB-node 705 (more precisely its IAB-MT) can detect the radio link deficiency. IAB-node 705 is therefore a detecting IAB-node. It then warns its child IAB-nodes, namely IAB-nodes 707 and 708, of the radio link deficiency. BH RLF Indication 600a, for instance as discussed above with reference to FIG. 6a, may be used to this purpose.

The description below is mainly provided with respect to an IAB-MT detecting a change in link conditions causing the sending of BH RLF Indication 600a for instance to its child IAB-nodes. The same consideration applies to an IAB-DU detecting a change in link conditions thus causing the sending of BH RLF Indication 600a for instance to its parent IAB-nodes.

BH RLF Indication 600a may specify the impacted BAP path, namely PATH 1 and PATH 5. Optionally, BH RLF Indication 600a may also be transmitted to IAB-Donor 701 (with a view of modifying the BAP paths declared in the network) and to IAB-node 702 which shares the deficient BH radio link 725, as being parent of detecting IAB-node 705. Detecting IAB-node 705 as well as child IAB-nodes 707, 708 and sharing IAB-node 702 may, based on the detected deficiency (as indicated in BH RLF Indication 600a) thus take corrective measures. These IAB-nodes may decide to reestablish new connection with a different parent IAB-node. They may also decide to reroute any received BAP packet assigned to an impacted BAP path over an alternate BAP path. For instance, IAB-node 705 may reroute, over PATH 2, BAP packets received from IAB-node 708 that are assigned to impacted PATH 1. Access IAB-nodes may select BAP paths avoiding the impacted BAP paths when they have to introduce BAP packets in the IAB network: for example, access IAB-node 708 may select PATH 3 for BAP packets to IAB-Donor 701 rather than PATH 1 (impacted one) or PATH 2 (on the side where BH RLF Indication 600a is received, i.e. where the network has deficiency).

Similarly, detecting IAB-node 705 may later detect an improvement of the BH radio link, hence a recovery of BH radio link 725. In the same way, a BH RLF Indication 600a may be transmitted to child IAB-nodes, IAB-Donor and sharing IAB-node. The measures (including a change of routing configuration for the IAB-nodes by the IAB-Donor) may then be stopped and the earlier situation be reinstalled.

The processes at these various IAB-nodes are now described according to some embodiments.

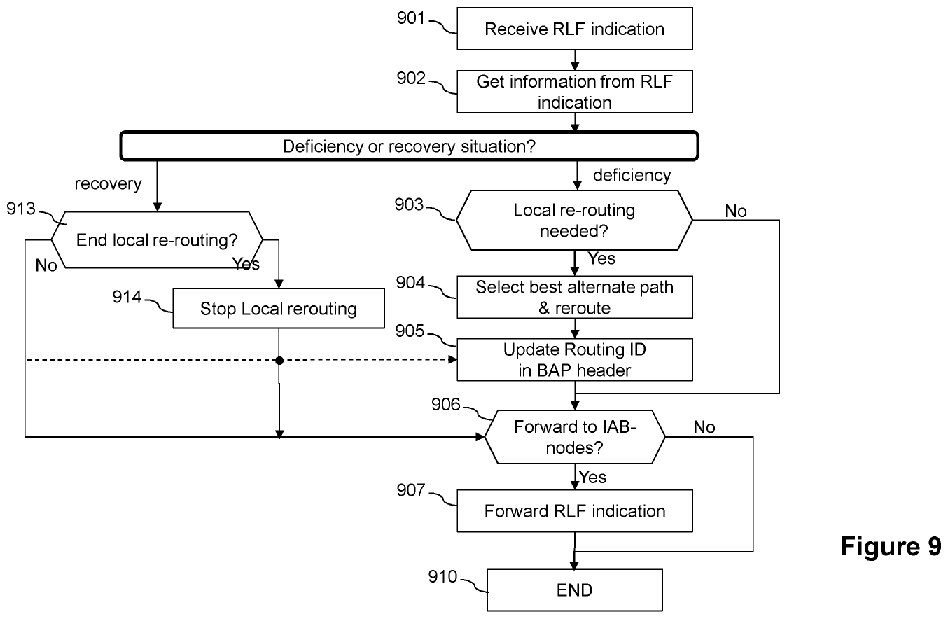

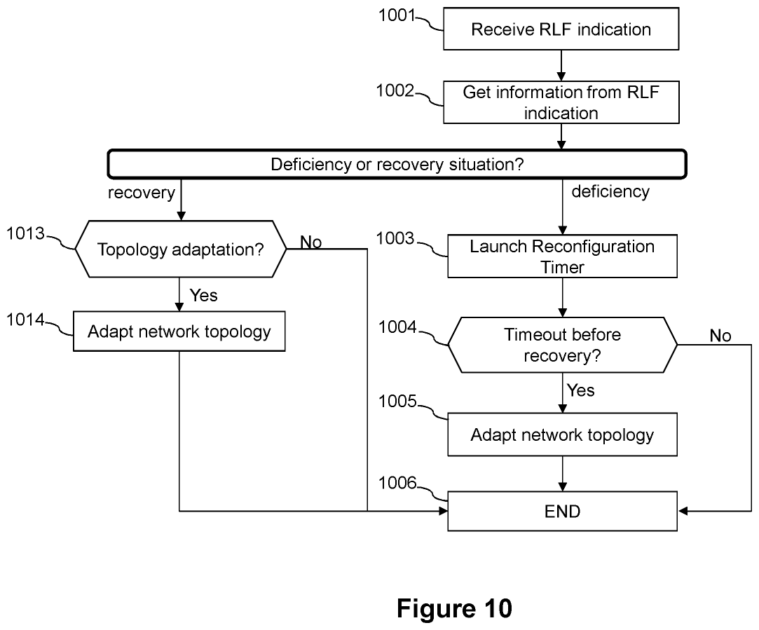

FIG. 8 illustrates, using a flowchart, general operations at the detecting IAB-node, e.g. IAB-node 705, according to embodiments of the invention. FIG. 9 illustrates, using a flowchart, general operations at a routing IAB-node when receiving a BH RLF Indication message 600a, according to embodiments of the invention. FIG. 10 illustrates, using a flowchart, general operations at the IAB-Donor when receiving a BH RLF Indication message 600a, according to embodiments of the invention. All these processes apply to BH RLF Indications 600a reporting a radio link deficiency/failure and reporting a radio link recovery.

Details provided below with respect to BH RLF Indication 600a and measures taken by the IAB-nodes can be applied to the invention in its broader scope, i.e. not to be limited to the particular embodiments of FIGS. 8 to 10.

Referring to FIG. 8, the process starts at step 801 where the detecting IAB-node detects a change in link conditions of one of the BH radio links. For instance, detecting IAB-node 705 detects a failure or deficiency or a recovery of BH radio link 725. As mentioned above, the IAB-MT of the detecting IAB-node detects failure or deficiency or recovery of one of its upstream BH radio links, while the IAB-DU of the detecting IAB-node detects failure or deficiency or recovery of one of its downstream BH radio links.

Mechanisms as contemplated for conventional RLF detection may be used. This allows detecting failure or recovery of the BH radio link, such as BH radio link 725.

Any method measuring a quality of the BH radio link ora congestion level of the IAB-node for that link may be used. The IAB-node may then compare the radio link quality level of the BH radio link to a quality threshold, or compare the congestion level of the BH radio link to a congestion threshold.

Should the RL quality level (respectively the congestion level) be greater (respectively lower) than a first deficiency threshold, the detecting IAB-node may consider the BH radio link as being deficient. A second deficiency threshold (representing worse radio link conditions) may also be used to declare when the BH radio link is failing (hence RL failure is detected). More generally, several thresholds may be considered, each of them being associated with a criticality level. The threshold or thresholds may be set in the IAB-node as a factory setting or configured by the IAB-Donor CU using a dedicated configuration message.

Reversely, should the RL quality level (respectively the congestion level) become lower (respectively higher) than a first recovery threshold, the detecting IAB-node may consider the BH radio link as being recovered. Also several thresholds may be considered. The recovery threshold or thresholds may be similar to or different from the deficiency threshold or thresholds.

Therefore, only a significant change in the link condition triggers the other steps of the process (to apply measures and notify the other IAB-nodes). With the several thresholds, the significant change consists in a decrease or an increase of the radio link quality or congestion level.

The radio link quality level may consist of a SINR (Signal-to-interference-plus-noise ratio) level or any other quality metric, such as a data packet loss or an average number of retransmissions per data packets. The one skilled in the art may easily identify other link quality metrics that could apply to the invention.

The congestion level is related to the ability for the IAB-node to process one or more incoming streams over its egress BH links to other IAB-nodes or its access links to UEs it is connected to. This congestion level may be related to a level of the internal buffers, or FIFOs, of the IAB-node associated with the BH radio link considered.

The RL quality level and congestion level can be expressed over a predefined range of levels, e.g. from 0 to 2ⁿ−1 (n being an integer).

Each IAB-node in the network may continuously monitor the link quality or congestion level of all its BH radio links. The process of FIG. 8 is executed for each detection of a link condition change.

Two subprocesses are performed should the detected link condition change mirrors a link deficiency (i.e. substantial decrease of radio link performance) or a link recovery (i.e. substantial increase of radio link performance).

In case of link deficiency, step 802 is executed where the detecting node determines one or more (preferably all) impacted Backhaul Adaptation Protocol, BAP, paths. That means it determines those BAP paths (as defined in its BH routing configuration tables) using the BH radio link. For example, detecting IAB-node 705 determines that PATH 1 and PATH 5 are impacted BAP paths.

To do so, it uses BH routing configuration table 500 and retrieves the BAP Routing IDs 501 corresponding to a Next Hop BAP Address 502 equal to the BAP Address of sharing IAB-node 702 sharing deficient BH radio link 725. The impacted BAP paths are the fields 306 included in the retrieved BAP Routing IDs.

Next at step 803, the detecting IAB-node determines (if possible) one BAP path alternate to each of the impacted BAP paths. To do so, it uses again its BH routing configuration table 500 to find one or more non-impacted BAP Routing IDs (e.g. specifying a non-impacted BAP path) sharing the same destination or destinations as the impacted BAP Routing IDs (i.e. specifying impacted BAP path). The BAP paths of these non-impacted BAP Routing IDs are alternate BAP path candidates.

The same alternate path candidate can be obtained for two or more or all the impacted BAP paths. Alternatively, an alternate path candidate can be determined independently for each impacted BAP path.

For illustrative purposes, detecting IAB-node 705 looks for a BAP path alternate to PATH 1 that may be currently used for relaying BAP packets received from child IAB-node 708. Detecting IAB-node 705 then checks whether there is a BAP Routing ID 501 in its Backhaul Routing Configuration table 500 that has the same DESTINATION field value, i.e. IAB-donor 701 address value, as BAP Routing ID 1 (i.e. the one specifying impacted PATH 1).

In case where no alternate path candidate can be found, the detecting IAB-node is unable to select a rerouting measure (as explained below) with a view of forwarding received BAP packets using another network path. The detecting IAB-node thus preferably buffers (step 810) received BAP packets that specify the impacted BAP path, until the deficient BH radio link is recovered.

Of course, if the deficient BH radio link is not fully failing, some of the BAP packets may still be transmitted over the BAP path as specified in the packets. One may however note that congestion is likely to happen at the detecting IAB-node.

For instance, assuming that only Routing ID 1 is set in the Backhaul Routing Configuration table 500 of detecting IAB-node 705, the latter should buffer the BAP packets received from child IAB-node 708 until BH radio link 625 is recovered from radio link failure.

In case where an alternate path candidate can be found, the detecting IAB-node is able to select a rerouting measure. Multiple alternate path candidates may also be available.

The detecting IAB-node may therefore check at step 804 the reliability of the alternate BAP path candidates, at least with respect to the corresponding egress BH links.

A reliability measure may be a quality or congestion level of the alternate BAP path candidates, or a reliability value combining both quality and congestion levels as measured by the detecting IAB-node.

In variants, the reliability measure may be the radio link quality level of the egress BH radio link corresponding to each alternate BAP path candidate, or the congestion level of the egress BH radio link. Also a probability or confidence level of recovery from a radio link failure (or deficiency) of the deficient BH radio link may be determined at step 804. The probability or confidence level may for example be determined from history data mirroring similar situations (e.g. mean time to have a BH radio link or this specific deficient BH radio link recovering from failure).

Step 804 is optional, meaning step 806 may be systematically performed.

However, preference is given to implement steps 804 and 805.

Based on the information (check) obtained at step 804, the detecting IAB-node may decide, at step 805, whether to reroute, over one of the alternate BAP path candidates, received (or incoming) BAP packets that specify one of the impacted BAP paths, or not.

In one embodiment, the detecting IAB-node systematically decides to locally re-route the incoming BAP packets over one of the alternate path candidates identified at step 803, regardless of their respective reliability checked at step 804 (or not checked in case step 804 is omitted).

In another embodiment, the detecting IAB-node never performs local re-routing. It thus systematically buffers (step 810) the incoming BAP packets.

In yet another embodiment, the detecting IAB-node may decide to locally re-route or not the incoming BAP packets based on the reliability measure as determined at step 804.

For example, the detecting IAB-node may decide to locally re-route the incoming BAP packet if it estimates that the probability or confidence level of recovering from the radio link failure/deficiency is too low (as checked at step 804).

In a variant, the detecting IAB-node may decide to locally re-route the incoming BAP packets over an egress BH radio link associated with an alternate path (identified at step 803) when the quality level of the deficient BH radio link reaches a predefined criticality level, i.e. its quality level (resp. congestion level) is below (resp. above) a predefined quality (resp. congestion) threshold as previously discussed with reference to step 801.

In another variant, the detecting IAB-node may decide not to locally re-route the incoming BAP packets over an alternate BAP path (identified at step 803) when a quality (resp. congestion) level the BH radio link associated with this alternate BAP path, or the alternate BAP path itself, is below (resp. above) a predefined quality (resp. congestion) threshold as previously discussed with reference to step 801.

Any combination of the aforementioned re-routing decision criteria may of course be used.

In case the detecting IAB-node decides not to re-route the incoming BAP packets, it buffers these packets (step 810), usually until the deficient BH radio link is recovered.

In case the detecting IAB-node decides to re-route the incoming BAP packets, it may select at step 806 the alternate BAP path or paths to use for the specific DESTINATION of these BAP packets, hence the egress BH radio link or links. If only one alternate BAP path candidate is identified at step 803, it is selected.

If several alternate path candidates exist for the same DESTINATION, the detecting IAB-node may randomly select one of them for the rerouting, or perform a round-robin selection of some or all of them to respectively reroute successive incoming BAP packets, or select the alternate path having the best reliability measure as determined at step 804.

For example, the detecting IAB-node selects the best alternate BAP path candidate as:
a BAP path candidate that does not have any radio link failure,
a BAP path candidate that offers the best path quality level,
a BAP path candidate that offers the lowest path congestion level,
a BAP path candidate that offers the best tradeoff between path quality level and congestion level.

In a variant, the detecting IAB-node selects a BAP path previously used by the IAB-node for routing packets over the IAB network.

Any combination of the aforementioned selection schemes may be considered.

Still at step 806, the detecting IAB-node actually re-routes the incoming BAP packets over the selected alternate BAP path. It is recalled that different alternate BAP paths are selected and therefore used to re-route incoming BAP packets addresses to different DESTINATIONs.

Note that the re-rerouting measure may last until the deficient/failed BH radio link is recovered from deficiency (i.e. its quality of congestion level has improved enough) or failure, as described below with reference to steps 813 and 814, or until a reconfiguration of BAP paths is made by the IAB-donor-CU.

For instance, detecting IAB-node 705 having Routing ID 1 and Routing ID 2 configured in its Backhaul Routing Configuration table 500 detects failure of BH radio link 725 (hence of default PATH 1 corresponding to Routing ID 1). It then decides to systematically re-route the incoming BAP packets from IAB-node 708, over an alternate path, e.g. PATH 2 (corresponding to Routing ID 2) through BH radio link 735.

To facilitate forwarding by other routing IAB-nodes, the detecting IAB-node may update a BAP routing identifier of the rerouted BAP packets to specify the alternate BAP path. Indeed, the routing IAB-nodes then have only to apply conventional forwarding process based on their respective Backhaul Routing Configuration table.

Next, at step 807, the detecting IAB-node checks whether it should send or not a BH RLF indication message 600a to IAB-nodes over all or part of its egress BH radio links.

In one embodiment, the detecting IAB-node systematically decides to send a BH RLF indication message 600a as soon as a link condition change is detected at step 801. It means step 807 is optional.

In another embodiment, the detecting IAB-node may estimate how fast the deficient BH radio link can be recovered. Hence, the probability or confidence level of recovery for the deficient BH radio link (as described above) may be used.

Should the recovery be expected quite soon (high probability of recovery), no BH RLF indication message 600a is sent. The process thus ends at step 809.

Should the deficiency persist, a BH RLF indication message 600a can be sent over all or part of its egress BH links.

Therefore, at step 808 (which also occurs after packet buffering at step 810), the detecting IAB-node builds and sends a BH RLF indication message 600a as described above with reference to FIG. 6a. Once the detecting IAB node knows the addressees of the BH RLF indication message 600a (e.g. child IAB-nodes 707, 708, sharing IAB-node 702, and/or IAB-Donor 701), it determines the egress BH radio links to be used, based on the configured egress BH RLC channels of the egress links indicated by BH RLC Channel ID IEs (associated with BAP Control PDU Channel set to true in TS 38.473). For instance, the egress links for the child IAB-nodes are those egress links associated with the IAB-DU of the detecting IAB-node. The egress links for the sharing IAB-node and/or IAB-donor are those egress links with such nodes as destination in the Backhaul Routing Configuration table 500.

If the detecting IAB-node wants or not to send the BH RLF indication message 600a to the IAB-Donor, it configures field 613 accordingly, to notify any intermediary/routing IAB-node (i.e. that will receive the RLF indication message) of its initial intent.

If the detecting IAB-node wants or not the BH RLF indication message 600a to reach the sharing IAB-node (sharing the deficient BH radio link), it configures fields 614 and 624 accordingly, to notify any intermediary/routing IAB-node (i.e. that will receive the RLF indication message) of its initial intent.

As mentioned above, the BH RLF indication message 600a may signal the impacted BAP paths or BAP Routing IDs 621, possibly with associated quality or congestion or the like levels 622. The sharing IAB-node may optionally be specified in field 624.

In variants, only quality or congestion information 622 is provided without any indication of an impacted BAP path or Routing ID. The quality or congestion information thus mirrors the link condition of the deficient radio link. For instance, this may be a discrete level in a predefined range. The sharing IAB-node may also optionally be specified in field 624.

In other variants, the sharing IAB-node 624 is specified alone.

The process ends after step 808.

Turning now to the recovery situation (i.e. the IAB-node detects a substantial improvement in a deficient BH radio link such as radio link 725), the detecting IAB-node checks, at step 812, whether it should stop performing any local re-routing initiated in a former step 806.

Criteria to decide may be the same as those of step 805, that are used in the reverse way. The same thresholds or different thresholds (different between examining deficiency and recovery) may be used. This makes it possible for the detecting IAB-node to determine whether the link condition situation has substantially improved (with respect to quality or congestion level for example) or even is back to normal.

The decision may be made for the impacted BAP paths, i.e. those that are now recovered thanks to the recovery of the deficient BH radio link.

In the negative, the process ends at step 809.

In the affirmative, the detecting IAB-node decides at step 813 to stop locally re-routing incoming BAP packets that use an impacted (now improved or recovered) BAP path or more generally that use the recovered BH radio link. It means that, for these incoming BAP packets, the detecting IAB-node routes them back over the impacted BAP path.

Next to step 814, the detecting IAB-node sends a BH RLF indication message 600a in the same way as done in step 808. A decision as to send or not such a message may also be taken as in step 807.

The BH RLF indication message 600a for deficiency (i.e. sent at step 808) and the BH RLF indication message 600a for recovery (sent at step 814) may have the same value for field 602, e.g. ‘0011’. In a variant, they may have different values, for example ‘0011’ for deficiency purposes and ‘0100’ (or any value in range 0100-1111) for recovery purposes.

The description turns now to an exemplary process at a routing IAB-node receiving the BH RLF Indication message 600a, as shown in FIG. 9. The routing IAB-node may be any intermediary IAB-node in the IAB network (e.g. IAB-node 706), including the sharing IAB-node (IAB-node 702), or an access IAB-node (IAB-node 708).

The process thus starts upon receiving a BH RLF Indication message 600a (step 901).

The routing IAB-node retrieves, at step 902, information embedded in fields 611 to 624 (more generally in the entry or entries 610).

This information makes it possible for the routing IAB-node to know whether a new deficient or recovery situation is signalled. For instance, field 602 may be used. In variants, values from Quality information field 622 may be used (for instance to be compared to known values for BAP paths).

In case a deficient situation is newly signalled (i.e. a BAP path is impacted), the routing IAB-node may decide to locally re-route incoming BAP packets. More generally, the routing IAB-node decides whether or not to adapt, based on the received information, a routing of BAP packets between routing over an impacted BAP path involving the BH radio link and routing over an alternate BAP path.

The local rerouting may be systematic.

In a variant, the decision is taken based on the information of the entry or entries 610. Decision criteria as those used at step 805 that are based on information included in the entry or entries may be used.

For illustrative purpose, rerouting may be decided for incoming BAP packets conveyed over an impacted BAP path indicated in the BH RLF Indication message 600a (either through a Path ID or a Routing ID), possibly depending on whether an alternate BAP path (determined as described above at step 803) exists.

In variants, rerouting may be decided depending on whether the impacted BAP path is substantially degraded, i.e. based on the corresponding Quality information 622 provided in the BH RLF Indication message 600a.

More generally, if the message 600a reports a substantial degradation of the radio link (e.g. when the message does not signal the impacted BAP paths), the routing IAB-node may decide rerouting, to an alternative egress link, incoming BAP packets usually forwarded over the BH radio link from where the message 600a comes.

The access IAB-nodes, and more generally any initiator IAB-node which introduces new BAP packets in the IAB network, can decide to perform a “rerouting” measure for new BAP packets. As this is the introduction of these BAP packets, this is not exactly a “rerouting” but a modified routing to take into account the signalled deficiency in the IAB network.

Child IAB-nodes (e.g. different from the sharing IAB-node as specified in field 624) can also try to reestablish a connection to a different parent IAB-node.

In case no rerouting is decided, the process continues at step 906.

Otherwise, it goes to step 904.

At step 904, similar to above step 806, an alternate BAP path or paths to use for the specific DESTINATION of the impacted incoming BAP packets is selected. The incoming BAP packets are then rerouted to the alternate BAP path or paths.

For example, the routing IAB-node selects the best alternate BAP path candidate as:
a BAP path candidate that does not have any radio link failure,
a BAP path candidate that offers the best path quality level (as specified in field 622 from amongst the BAP path candidates),
a BAP path candidate that offers the lowest path congestion level (as specified in field 622 from amongst the BAP path candidates),
a BAP path candidate that offers the best tradeoff between path quality level and congestion level.

In a variant, the routing IAB-node selects a BAP path previously used by the IAB-node for routing packets over the IAB network.

Any combination of the aforementioned selection schemes may be considered.

During step 904, incoming BAP packets are actually rerouted to the selected alternate BAP path or paths, given the original Routing ID specified in the incoming BAP packets.

Optionally, to facilitate forwarding by other routing IAB-nodes, the routing IAB-node may update a BAP routing identifier of the rerouted BAP packets to specify the alternate BAP path used.

Note that for an initiator IAB-node, step 904 consists in determining an alternate BAP paths to the one it should select normally.

Optional step 905 may consist for the routing IAB-node to update the RLF Indication Entries 610 with local estimations of its BH radio links.

For instance, if the routing IAB-node estimates that one of its egress BH radio links used by a BAP path has radio conditions worse than the received Quality information 622 of that BAP path, it may accordingly update this Quality information. This will help other routing IAB-nodes to efficiently determine the opportunity to perform rerouting or not, and to choose the best alternate BAP path.

Preferably, the update is only made based on an estimated quality/congestion level of the BH radio link over which the BH RLF Indication message 600a was received.

Step 905 may thus consist in updating link condition information 622 specified within the message 600a and relating to an impacted BAP path involving the deficient BH radio link, based on an evaluated link condition of one of its BH radio link, for instance the BH radio link over which the indication message is received.

Next to step 905, the routing IAB-node checks, at step 906, whether it should forward the received BH RLF Indication message 600a to one or more IAB-nodes. In the affirmative, the received BH RLF Indication message 600a is forwarded to them.

The routing IAB-node forwards the received BH RLF Indication message 600a to one or more IAB-nodes given the topology of the IAB network.

For instance, if the BH RLF Indication message 600a is received by the IAB-MT over an egress link associated with IAB-MT, then the message is transmitted over the egress BH radio links associated with the collocated IAB-DU. Furthermore, if field 613 is enabled (forward to IAB-Donor), the message is also forwarded over the other egress BH radio links associated with the IAB-MT (i.e. excluding the link receiving the message).

If the BH RLF Indication message 600a is received by the IAB-DU from an egress link associated with IAB-DU, then the message is transmitted over the egress BH radio links associated with the IAB-MT.

In some embodiments, the routing IAB-node checks whether it should forward the BH RLF Indication message 600a to the IAB-Donor or to the sharing IAB-node (sharing the deficient radio link). The decision may be merely based on an indication, namely field 613 and/or 624, retrieved from the received message. For instance, if field 613 indicates that the received BH RLF Indication message 600a should be forwarded to the IAB-Donor, the routing IAB-node checks in its BAP routing configuration table 501 for a BAP path reaching the IAB-Donor. It is to be noted that if field 613 is set to forward the message 600a to the IAB-Donor, the messages 600a forwarded at step 907 to another node than IAB-Donor are also modified to deactivate such forwarding to the IAB-Donor (i.e. first 613 is modified to the other value). This is to avoid multiplying the copies of the same message 600a (flooding phenomena) that are addressed to the same entity, namely the IAB-Donor. Therefore, the routing IAB-node deletes the IAB-donor forwarding indication from the message 600a forwarded to one or more IAB-nodes when the same received indication message is forwarded to the IAB-donor.

Also, if field 714 indicates that the received message 600a should be forwarded to the sharing IAB-node indicated in field 624, the routing IAB-node checks in its BAP routing configuration table 501 for a BAP path reaching the sharing IAB-node. The BH RLF Indication message 600a is then forwarded (step 907) on the corresponding BH radio link, if a BAP path is found.

Of course, if the routing IAB-node is also the sharing IAB-node (i.e. if field 624 identifies the routing IAB-node), there is no need to try to forward the message 600a to the sharing IAB-node.

The process then ends at step 910.

Turning now to the recovery situation (i.e. the received message 600a signals a radio link recovery), the process is quite similar to FIG. 8.

The routing IAB-node first checks, at step 913, whether it should stop performing any local re-routing initiated in a former step 904. The decision is based on the information retrieved from received message 600a, for instance the impacted BAP paths and associated Quality information. The decision criteria may be the same as those of step 903, that are used in the reverse way.

The routing IAB-node may for example estimate whether the situation is back to normal, meaning there is no more RLF or the link quality/congestion level has reached an acceptable level.

In the negative, the process continues at step 906 to forward the received message 600a. Optionally, any Quality information 622 of the received message 600a may be updated (step 905, as described above) based on a local estimate of the quality/congestion level of the egress BH radio links, in particular of the links over which message 600a is received.

In the affirmative, the routing IAB-node decides at step 914 to stop locally re-routing incoming BAP packets that use an impacted (now improved or recovered) BAP path. If no impacted BAP path is signalled in the message 600a, the stopping of the rerouting may concern all the incoming BAP packets. For these incoming BAP packets, the routing IAB-node routes them back to the impacted BAP path (i.e. former BAP path relied on before detecting a deficiency situation).

As the former BAP path is used again, no update of the BAP header of the new incoming BAP packets is required because they include the default one.

Next to step 914, the process goes to step 906 to forward the received message 600a. Optionally, any Quality information 622 of the received message 600a may be updated (step 905, as described above) based on a local estimate of the quality/congestion level of the egress BH radio links, in particular of the links over which message 600a is received.

The description turns now to an exemplary process at the IAB-Donor receiving the BH RLF Indication message 600a, as shown in FIG. 10.

The process thus starts upon receiving a BH RLF Indication message 600a (step 1001). This message was sent by the detecting IAB-node and has been forwarded by one or more intermediary/routing IAB-nodes.

The IAB-Donor retrieves, at step 1002, information embedded in fields 611 to 624 (more generally in the entry or entries 610).

This information makes it possible for the IAB-Donor to known whether a new deficient or recovery situation is signalled. For instance, field 602 may be used. In variants, values from Quality information field 622 may be used (for instance to be compared to known values for BAP paths).

Depending on this information, the IAB-donor may decide to reconfigure IAB-nodes to adapt to the topology of the IAB-network. It means the IAB-donor may adapt the routing configuration of the IAB-nodes

In case the message 600a reports a deficiency of a BH radio link, the IAB-Donor may launch a Reconfiguration Timer at step 1003. This is to avoid modifying the routing configuration of the IAB-nodes should another message 600a reporting a recovery of the same BH radio link be received soon. The timer is thus started upon receiving the message 600a indicating a deficiency of the BH radio link and is stopped upon receiving a further indication message indicating a recovery of the BH radio link.

The Reconfiguration Timer is however optional, meaning the routing configuration adaptation may be immediately initiated at step 1005, by skipping steps 1003 and 1004.

Expiry of the timer is detected through step 1004. If it is stopped, no routing configuration adaptation is made and the process ends at step 1006.

Otherwise, a routing configuration adaptation to the network topology is made given the notified deficiency. This adaption may merely consist in configuring the BAP routing configuration tables of one or more IAB-nodes in the IAB network.

For example, the impacted BAP paths listed in message 600a may be deleted from the previous network topology.

In addition, these BAP paths may allow the IAB-Donor to identify the deficient BH radio link (as the common radio link between all the impacted BAP paths). Consequently, the routing configuration of the IAB-nodes may be modified to avoid using this deficient BH radio link.

More generally, the routing configuration of the IAB-nodes may be adapted by withdrawing, from it, one or more BAP paths involving the BH radio link when the received message 600a indicates a deficiency of the BH radio link.

For example, upon receiving a BH RLF Indication message 600a issued by detecting IAB-node 705 and reporting a deficiency of BH radio link 725, IAB-Donor 701 may suppress PATH 1 and reconfigure IAB-node 608 so that it uses PATH 2 instead of its default PATH 1.

The process ends at step 1006 after step 1005.

Turning now to the recovery situation (i.e. the received message 600a signals a radio link recovery), the IAB-Donor checks, at step 1013, whether it should perform a routing configuration adaptation. This may for instance depend on the magnitude of the improvement of the deficient HB radio link (which may be estimated thanks to the Quality information 622 of the impacted BAP paths, with respect to one or more thresholds).

In case, the IAB-Donor estimates that the situation is back to normal or at least has improved in a sufficient way, it adapts, at step 1014, the routing configuration of IAB-nodes to the improved network topology. This may be done with a view of restoring all or part of the former routing configurations it had set up before detecting a deficiency situation and performing a former routing configuration adaptation at step 1005.

More generally, the routing configuration of the IAB-nodes may be adapted by reintroducing, in the routing configuration, one or more impacted BAP paths involving the deficient BH radio link when the received message 600a indicating a recovery of the BH radio link.

This adaption may merely consist in configuring the BAP routing configuration tables of one or more IAB-nodes in the IAB network, to restore a former communication path.

For example, upon receiving a BH RLF Indication message 600a issued by detecting IAB-node 705 and reporting a recovery of BH radio link 725, IAB-Donor 701 may reintroduce formerly-suppressed PATH 1 and reconfigure IAB-node 608 so that it now switches back to default PATH 1 instead of temporary-used PATH 2.

It is provided hereafter, for clarity purpose, an illustration of some aspects of the present invention.

As mentioned previously, in the Rel-16 specification TS 38.340, the control BAP PDU for RLF indication conveys the D/C bit 701, the 4-bit PDU type field 702 as well as 3 empty bits reserved for future use.

There may be some cases where an IAB-node with dual-connectivity uses both links for load balancing purpose. Indeed, if the capacity of one link is not sufficient to accommodate the total throughput, then some packets associated with one or several BAP path ID(s) would be transmitted through the first parent, while other packets associated with different BAP path ID(s) would be transmitted through the second parent.

If a BH RLF occurs for one of the parent links, the IAB-node may try to reroute the packets through the alternative link.

In this respect, sending a BH RLF indication to the child IAB-node(s) would be useful to trigger some rerouting by the child IAB-node(s). In relation with Release 17 IAB framework, 3GPP is considering four types of BH RLF indication messages, i.e. Type 1, 2, 3 or 4.

However, upon reception of such RLF indication from a parent IAB-node, a child IAB-node may try to reroute all the packets initially intended for this parent IAB-node through an alternative BH link, which may create a risk of congestion on this alternative link.

For this purpose, in order to help a child IAB-node to take the right decision for rerouting, it is proposed that the BH RLF indication format is enhanced so that it carries the list of the BAP path ID(s) impacted by the RLF. A child IAB-node receiving this enhanced RLF indication may thus be able to reroute only the packets associated with the BAP path ID belonging to the received list.

Therefore, in one embodiment of the present invention, a BH RLF indication may convey a list of BAP path ID(s) or BAP Routing ID(s) impacted by the RLF.

In this respect, in relation with FIG. 6a and FIG. 8, an RLF indication message 600a may carry several RLF Indication Entries 610, where each entry includes a Path ID field 621.

For instance, let's consider the IAB network topology of FIG. 7, which illustrates a configuration of upstream BAP paths for two IAB-nodes (707 and 708).

If a BH RLF occurs between IAB-node 705 and IAB-node 702, IAB-node 705 may send a BH RLF indication (Type 1 or Type 2) including the list [PATH 1, PATH 5] to its child IAB-nodes 707 and 708. As a consequence, IAB-node 708 may reroute packets associated with path ID 1 through a different IAB-node, e.g. IAB-node 706. In case of RLF recovery, IAB-node 705 may send a BH RLF indication Type 3 including the list [PATH 1, PATH 5] to indicate those paths are available again.

From the previous example, it can be noticed that IAB-node 708 has three configured paths, i.e. PATH 1, PATH 2 and PATH 3, but has no information on which of these three paths is the best for rerouting.

Thus, an IAB-node may not take the best decision for local rerouting because of a lack of knowledge on the actual quality of its several alternative transmission paths.

In relation with FIG. 6a and FIG. 8, in aspects of the present invention, an IAB-node may send some information on the quality level of each BAP path in its BH Routing Configuration to its child IAB-node(s). The quality level may be related to the radio link conditions (e.g. SINR) and/or to the congestion status of the link towards the parent IAB-node. In one embodiment of the invention, the quality level information may be sent only when there is a significant change for one path.

The quality level for several paths may be carried by a BH RLF indication message 600a (Type 1, 2, 3, or 4). It may also be transmitted through another type of BH RLF indication message (e.g. Type 5: BH Path Quality level indication) or through a new type of indication message.

Thus, in one aspect of the invention, some information related to the quality level associated with all or part of the BAP paths or the BAP Routing IDs handled by an IAB-node may be transmitted to the child IAB-node(s) through a BH RLF indication message.

In another aspect of the invention, the quality level associated with a BAP path or a BAP Routing ID may refer to the radio link conditions (e.g. SINR) and/or the congestion level of an associated BH link.

In another aspect of the invention, the information related to the quality level associated with all or part of the BAP paths or the BAP Routing IDs handled by an IAB-node may be transmitted to the child IAB-node(s) through a new type of BH RLF indication, e.g. Type 5, or through a dedicated BAP control PDU, e.g. Radio Link Quality (RLQ) indication.

Back to the IAB network topology of FIG. 7, IAB-node 705 may transmit a BH RLF indication including the quality level of PATH 1, PATH 2, PATH 4, and PATH 5 to IAB-nodes 707 and 708. The quality levels of PATH 4 and PATH 2 depend on the status of BH link 735 between IAB-node 703 and IAB-node 705. The quality levels of PATH 5 and PATH 1 depend on the status of BH link 725 between IAB-node 702 and IAB-node 705. Assuming a BH RLF on BH link 725, impacting PATH 5 and PATH 1, IAB-node 708 may compare the quality level of paths PATH 1, PATH 2, and PATH 3 (which it may have previously received from IAB-node 706) and decide to reroute the packets associated with PATH 1 to the best path between PATH 2 and PATH 3, i.e. the path having the highest quality level.

We observe, in the present invention, that when the IAB-node receiving a BH RLF indication (Type 1, 2 or 4) does not have any alternative path, there is no possibility for the IAB-node to perform any rerouting in the upstream direction. In such a case, the IAB-node should forward the RLF indication to its own child IAB-node(s) which may have dual connectivity for local rerouting.

Therefore, in one embodiment of the invention, in relation with FIG. 9, upon reception of a BH RLF indication from a parent IAB-node, an IAB node without any alternative path should forward the RLF indication to its own child IAB node(s).

Going further, still in relation with FIG. 9, it may be advantageous that a BH RLF indication is forwarded to the child IAB-node that generated the packets to reroute (e.g. an access IAB-node for a UE). Indeed, such an IAB-node should have the largest number of possible alternative paths to send its packets (provided those paths have been configured by the IAB-donor-CU). Moreover, selecting a new path ID from the IAB-node generating the packets would avoid any additional processing at intermediate relay IAB-nodes (e.g. on-the-fly rerouting).

However, the IAB-node needs some information on the quality level of each path in order to select the best one.

Therefore, in one embodiment of the invention, in relation with FIG. 9, a BH RLF indication including BAP path ID(s) or BAP Routing ID(s) (with or without the quality level) should be forwarded by an IAB-node to its child IAB node(s).

Up to now, we have considered the downstream transmission and forwarding of RLF indication with the purpose of rerouting in a descendant IAB-node. This is useful to reduce service interruption of upstream traffic waiting for a BAP configuration update from the IAB-donor-CU. However, as RLF indication is not transmitted to a parent IAB-node, packets rerouting for downstream traffic may not be triggered, with a risk of congestion and then service interruption, before a new BAP configuration is applied by the IAB-donor-CU.

For instance, considering the IAB network topology 700 of FIG. 7, if a BH RLF occurs on BH link 758 between IAB-node 705 and IAB-node 708, IAB-node 702 is not aware of this RLF even though it could reroute packets through IAB-node 706 using PATH 3.

We may conclude from the aforementioned situation that packet rerouting in downstream direction following a BH RLF may require a BAP configuration update from the IAB-donor-CU.

Therefore, in relation with FIG. 9 of the present invention, it is proposed that an IAB-node receiving a BH RLF indication including the quality level of BAP Routing ID(s) may forwards this RLF indication in the upstream direction when possible. The objective is to reach a parent IAB-node capable of re-routing data packets, and ultimately to reach the IAB-donor, firstly to reroute packets, and secondly to update the BAP configuration of IAB-nodes if necessary. In this respect, an IAB-node receiving the BH RLF indication checks its BAP routing tables to identify the next hop(s), i.e. the egress link(s), associated with the Routing ID having the IAB-donor address as destination. The RLF indication is then forwarded over the identified egress link(s) but different from the link on which the RLF indication was received.

Thus, in one embodiment of the invention, a BH RLF indication including BAP Routing ID(s) (with or without the quality level) should be forwarded by an IAB-node through the egress link(s) associated with the destination BAP address of the IAB-donor, except for the egress link on which the RLF indication was received.

When forwarding a BH RLF indication including the quality level associated with BAP path(s) or BAP Routing ID(s), an IAB-node may update the quality level according to its own estimation. If the quality level estimated by the IAB-node for a given BAP path or BAP Routing ID is lower than the quality level indicated in the received RLF indication, then the IAB-node may update this quality level when forwarding the RLF indication. If the quality level estimated by the IAB-node for a given BAP path is better than or equal to the quality level indicated in the received RLF indication, then the IAB-node does not update the RLF indication.

Thus, in one embodiment of the invention, when forwarding a BH RLF indication including the quality level associated with BAP path(s) or BAP Routing ID(s), an IAB-node may update the quality level associated with a BAP path or a BAP Routing ID, which is estimated as lower than the quality level indicated in the received RLF indication.

According to Release 16, when rerouting is decided and applied by an IAB-node, the rerouted packets will take a path that does not correspond to the Routing ID in their BAP header (PATH field). The IAB-node receiving the rerouted packets may not have the corresponding Routing ID as an entry in its routing table. Although the IAB-node can route the packets according to the destination BAP address only, it is preferable, for an optimized routing, that the Routing ID of the packets matches with the path that is actually taken. For this purpose, the IAB-node that performs rerouting should update the BAP path ID in the header of the rerouted packets.

In particular, in order to avoid any Routing ID update at intermediate IAB-nodes, an access IAB-node (for upstream traffic) or the IAB-donor-DU (for downstream traffic) should update the BAP path ID in the header of the rerouted packets.

Therefore, in one embodiment of the invention, an IAB-node performing local rerouting should update the BAP path ID in the header of the rerouted packets to reflect the new path taken by the packets.

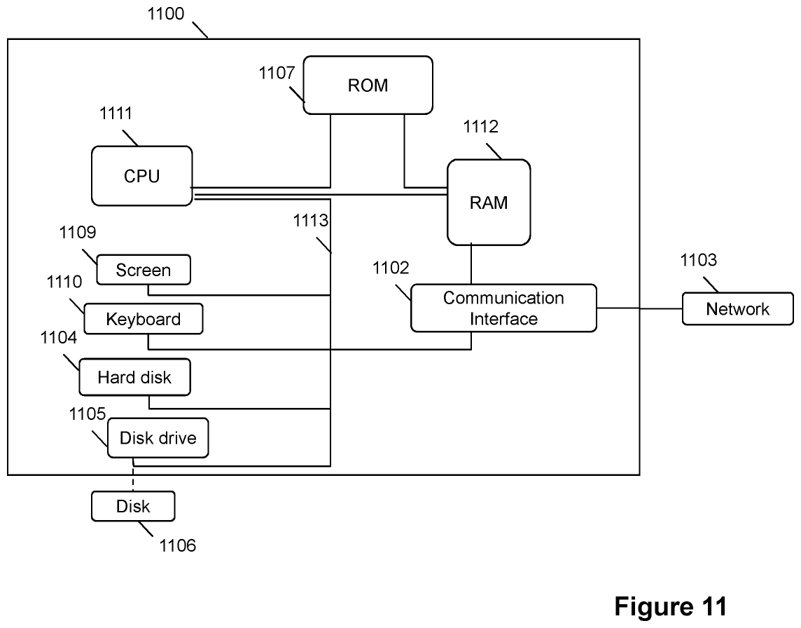

FIG. 11 shows a schematic representation a communication device or station, in accordance with one or more example embodiments of the present disclosure.

The communication device 1100 may preferably be a device such as a micro-computer, a workstation or a light portable device. The communication device 1100 comprises a communication bus 1113 to which there are preferably connected:
a central processing unit 1111, such as a microprocessor, denoted CPU;
a read only memory 1107, denoted ROM, for storing computer programs for implementing the invention;
a random-access memory 1112, denoted RAM, for storing the executable code of methods according to embodiments of the invention as well as the registers adapted to record variables and parameters necessary for implementing methods according to embodiments of the invention; and
at least one communication interface 1102 connected to the radio communication network 100 over which digital data packets or frames or control frames are transmitted, for example a wireless communication network according to the release 16 for 5G NR. The frames are written from a FIFO sending memory in RAM 1112 to the network interface for transmission or are read from the network interface for reception and writing into a FIFO receiving memory in RAM 1112 under the control of a software application running in the CPU 1111.

Optionally, the communication device 1100 may also include the following components:
a data storage means 1104 such as a hard disk, for storing computer programs for implementing methods according to one or more embodiments of the invention;
a disk drive 1105 for a disk 1106, the disk drive being adapted to read data from the disk 1106 or to write data onto said disk;
a screen 1109 for displaying decoded data and/or serving as a graphical interface with the user, by means of a keyboard 1110 or any other pointing means.

Preferably the communication bus provides communication and interoperability between the various elements included in the communication device 1100 or connected to it. The representation of the bus is not limiting and in particular, the central processing unit is operable to communicate instructions to any element of the communication device 1100 directly or by means of another element of the communication device 1100.

The disk 1106 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 1107, on the hard disk 1104 or on a removable digital medium such as for example a disk 1106 as described previously. According to an optional variant, the executable code of the programs can be received by means of the communication network 1103, via the interface 1102, in order to be stored in one of the storage means of the communication device 1100, such as the hard disk 1104, before being executed.

The central processing unit 1111 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 1104 or in the read only memory 1107, are transferred into the random-access memory 1112, which then contains the executable code of the program or programs, as well as registers for storing the variables and parameters necessary for implementing the invention.

In a preferred embodiment, the apparatus is a programmable apparatus which uses software to implement the invention. However, alternatively, the present invention may be implemented in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method in a wireless communication network comprising an Integrated Access and Backhaul, IAB, network, the method comprising, at a detecting IAB-node having Backhaul, BH, radio links established with other IAB-nodes:
detecting a change in link conditions of one of the BH radio links, and
responsive to the detection, sending an indication message to at least one of the other IAB-nodes,
wherein the indication message indicates a detected link condition change in the IAB network and further provides information relating to the BH radio link.

2. The method of claim 1, wherein detecting a change includes
detecting a deficiency in the BH radio link,
a recovery of the BH radio link previously deficient, or
a radio link failure or a recovery from a radio link failure, comparing a radio link quality level of the BH radio link to a quality threshold, or comparing a congestion level of the BH radio link to a congestion threshold.

3-4. (canceled)

5. The method of claim 1, wherein the other IAB-node or nodes to which the indication message is sent include one or more of:
one or more child or parent IAB-nodes given a topology of the IAB network,
an IAB-donor at the top of the IAB network topology, and
a sharing IAB-node sharing the BH radio link with the detecting IAB-node.

6. The method of claim 1, wherein when the change in link conditions is detected by an IAB-mobile termination of the detecting IAB-node, the other IAB-node or nodes to which the indication message is sent include one child IAB-node given a topology of the IAB network, and
when the change in link conditions is detected by an IAB-distributed unit of the detecting IAB-node, the other IAB-node or nodes to which the indication message is sent include one parent IAB-node given a topology of the IAB network.

7. A method in a wireless communication network comprising an Integrated Access and Backhaul, IAB, network, the method comprising, at a routing IAB-node:
receiving, from another IAB-node, an indication message, wherein the indication message indicates a detected link condition change in the IAB network and further provides information relating to a BH radio link concerned by the link condition change,
deciding to adapt, based on the received information, a routing of Backhaul Adaptation Protocol, BAP, packets between routing over an impacted BAP path involving the BH radio link and routing over an alternate BAP path.

8. The method of claim 7, further comprising, at the routing IAB-node, forwarding the indication message to one or more child IAB-nodes give a topology of the IAB network.

9. The method of claim 8, further comprising, at the routing IAB-node, updating link condition information specified within the indication message and relating to an impacted Backhaul Adaptation Protocol, BAP, path involving the BH radio link, based on an evaluated link condition of one of its egress BH radio link.

10. The method of claim 7, further comprising, at the routing IAB-node,
retrieving, from the received indication message, an indication as to whether forwarding the indication message to an IAB-donor of the IAB network or to a sharing IAB-node of the BH radio link or not, and
accordingly forwarding the received indication message to the IAB-donor and/or to the sharing IAB-node.

11. The method of claim 10, further comprising, at the routing IAB-node, deleting the IAB-donor forwarding indication from the indication message or messages forwarded to one or more IAB-nodes when the same received indication message is forwarded to the IAB-donor.

12. The method of claim 1, further comprising, at the detecting or routing IAB-node, determining one or more impacted Backhaul Adaptation Protocol, BAP, paths involving the BH radio link.

13. The method of claim 1, further comprising, at the detecting or routing IAB-node, determining one BAP path alternate to one of the impacted BAP paths and rerouting, over the alternate BAP path, received BAP packets that specify the impacted BAP path.

14. The method of claim 1, further comprising, at the detecting or routing IAB-node, determining one BAP path alternate to one of the impacted BAP paths and rerouting, over the alternate BAP path, received BAP packets that specify the impacted BAP path.

15. The method of claim 14, further comprising, at the detecting or routing IAB-node, updating a BAP routing identifier of the received and rerouted BAP packets to specify the alternate BAP path.

16. The method of claim 1, further comprising, at the detecting or routing IAB-node, stop rerouting received BAP packets that specify one of the impacted BAP paths over an alternate BAP path, and routing back such received BAP packets to the impacted BAP path.

17. The method of claim 7, further comprising,
at the detecting or routing IAB-node, stop rerouting received BAP packets that specify one of the impacted BAP paths over an alternate BAP path, and routing back such received BAP packets to the impacted BAP paths.

18-19. (canceled)

20. The method of claim 1, wherein the information relating to the BH radio links signals one or more impacted Backhaul Adaptation Protocol, BAP, paths involving the BH radio link.

21. The method of claim 7, wherein the information relating to the BH radio links signals one or more impacted Backhaul Adaptation Protocol, BAP, paths involving the BH radio link.

22. The method of claim 1, wherein the information relating to the BH radio links is a BAP Routing ID.

23. The method of claim 7, wherein the information relating to the BH radio links is a BAP Routing ID.

24. (canceled)

25. The method of claim 22,
wherein the information relating to the BH radio link further includes link condition information relating to each impacted BAP path, and
wherein the link condition information includes one or a combination of
a radio link quality level of the BH radio link,
a congestion level of the BH radio link,
a path quality level of an impacted Backhaul Adaptation Protocol, BAP, path involving the BH radio link, and
a confidence level of recovery from a radio link failure of the BH radio link.

26-28. (canceled)

29. A wireless communication device comprising at least one microprocessor configured for carrying out the steps of the method of claim 1.

30. A wireless communication device comprising at least one microprocessor configured for carrying out the steps of the method of claim 7.

31-32. (canceled)

33. The method of claim 7, further comprising, at the detecting or routing IAB-node, determining one or more impacted Backhaul Adaptation Protocol, BAP, paths involving the BH radio link.
